(19) United States
(12) Patent Application Publication
(10) Pub. No.: US 2024/0166892 A1
(43) Pub. Date: May 23, 2024

(54) ELECTRODEPOSITABLE COATING COMPOSITIONS

(71) Applicant: PPG Industries Ohio, Inc., Cleveland, OH (US)

(72) Inventors: David Alfred Stone, Allison Park, PA (US); Egle Puodziukynaite, Ridgecrest, CA (US); Reza Michael Rock, Pittsburgh, PA (US); Vijesh Anant Tanna, Pittsburgh, PA (US); Andrey Vladimirovich Chernykh, Cranberry Township, PA (US); James Charles Serene, Lower Burrell, PA (US); Corey James Dedomenic, Trafford, PA (US); Christophe R.G. Grenier, Pittsburgh, PA (US)

(73) Assignee: PPG Industries Ohio, Inc., Cleveland, OH (US)

(21) Appl. No.: 18/548,757

(22) PCT Filed: Mar. 4, 2022
(86) PCT No.: PCT/US2022/070969

§ 371 Date: Sep. 1, 2023

Related U.S. Application Data
(60) Provisional application No. 63/157,356, filed on Mar. 5, 2021.

(51) Int. Cl. C09D 5/44; C09D 7/45; C09D 7/65; C09D 175/08

(52) U.S. Cl. CPC C09D 5/4476; C09D 5/4465; C09D 5/4473; C09D 5/448; C09D 7/45; C09D 7/65; C09D 175/08

(57) ABSTRACT

The present disclosure is directed to an electrodepositable coating composition comprising an addition polymer comprising a polymerization product of a polymeric dispersant and a second stage ethylenically unsaturated monomer composition comprising a second stage (meth)acrylamide monomer; an ionic salt group-containing film-forming polymer different from the addition polymer; and a curing agent. Also disclosed are coatings, coated substrates, and methods of coating a substrate.

### FIELD

The present disclosure is directed towards an electrodepositable coating composition, coated substrates, and methods of coating substrates.

### BACKGROUND

Electrodeposition as a coating application method involves the deposition of a film-forming composition onto a conductive substrate under the influence of an applied electrical potential. Electrodeposition has gained popularity in the coatings industry because it provides higher paint utilization, outstanding corrosion resistance, and low environmental contamination as compared with non-electrophoretic coating methods. Both cationic and anionic electrodeposition processes are used commercially.

An electrodepositable coating composition that provides crater control and edge coverage is desired.

### BRIEF DESCRIPTION OF THE DRAWINGS

FIG. 1A is a front view showing the dimensions in inches of a laser-cut hot rolled steel panel used in the Examples section.

FIG. 1B is a side view showing a thickness of 0.13 inches of a laser-cut hot rolled steel panel used in the Examples section.

### SUMMARY

The present disclosure provides an electrodepositable coating composition comprising an addition polymer comprising a polymerization product of a polymeric dispersant and a second stage ethylenically unsaturated monomer composition comprising a second stage (meth)acrylamide monomer; an ionic salt group-containing film-forming polymer different from the addition polymer; and a curing agent.

The present disclosure also provides a method of coating a substrate comprising electrophoretically applying the electrodepositable coating composition of the present disclosure to at least a portion of the substrate.

The present disclosure further provides a coated substrate having a coating comprising (a) an addition polymer comprising a polymerization product of a polymeric dispersant and a second stage ethylenically unsaturated monomer composition comprising a second stage (meth)acrylamide monomer; (b) an ionic salt group-containing film-forming polymer different from the addition polymer; and (c) a curing agent.

The present disclosure further provides a coated substrate having a coating comprising (a) an addition polymer comprising a polymerization product of a polymeric dispersant and a second stage ethylenically unsaturated monomer composition comprising at least 20% by weight of a second stage hydroxyl-functional (meth)acrylamide monomer, based on the total weight of the second stage ethylenically unsaturated monomer composition; (b) an ionic salt group-containing film-forming polymer different from the addition polymer; and (c) a curing agent.

### DETAILED DESCRIPTION

The present disclosure is directed to an electrodepositable coating composition comprising an addition polymer comprising a polymerization product of a polymeric dispersant and a second stage ethylenically unsaturated monomer composition comprising a second stage (meth)acrylamide monomer; an ionic salt group-containing film-forming polymer different from the addition polymer; and a curing agent.

According to the present disclosure, the term “electrodepositable coating composition” refers to a composition that is capable of being deposited onto an electrically conductive substrate under the influence of an applied electrical potential.

### Addition Polymer

According to the present disclosure, the electrodepositable coating compositions of the present disclosure may comprise an addition polymer comprising a polymerization product of a polymeric dispersant and a second stage ethylenically unsaturated monomer composition comprising a second stage (meth)acrylamide monomer.

As used herein, the term “addition polymer” refers to a polymerization product at least partially comprising the residue of unsaturated monomers.

The polymerization product may be formed by a two-stage polymerization process, wherein the polymeric dispersant is polymerized during the first stage and the second stage ethylenically unsaturated monomer composition is added to an aqueous dispersion of the polymeric dispersant and polymerized in the presence of the polymeric dispersant that participates in the polymerization to form the addition polymer during the second stage.

According to the present disclosure, the polymeric dispersant may comprise any polymeric dispersant having a sufficient salt-group content to stably disperse and participate in a subsequent polymerization of a second stage ethylenically unsaturated monomer composition and to provide for a resulting addition polymer that is stable in an electrodepositable coating composition. Although reference is made to the polymeric dispersant polymerized during the first stage, it will be understood that pre-formed or commercially available dispersants may be used, and the prior formation of the polymeric dispersant would be considered to be first stage polymerization.

According to the present disclosure, the polymeric dispersant polymerized during the first stage may comprise the polymerization product of a first stage ethylenically unsaturated monomer composition.

The first stage ethylenically unsaturated monomer composition comprises one or more monomers that allow for the incorporation of ionic salt-groups into the polymeric dispersant such that the polymeric dispersant comprises an ionic salt group-containing polymeric dispersant. For example, the polymeric dispersant may comprise cationic salt groups such that the polymeric dispersant comprises a cationic salt group-containing polymeric dispersant or anionic salt groups such that the polymeric dispersant comprises an anionic salt group-containing polymeric dispersant. The cationic salt groups may be formed by incorporation of an epoxide functional unsaturated monomer, an amino functional unsaturated monomer, or a combination thereof, and subsequent neutralization. For example, the polymeric dispersant may comprise a cationic salt group-containing polymeric dispersant comprising a polymerization product of a first stage ethylenically unsaturated monomer composition comprising an epoxide functional ethylenically unsaturated monomer, and/or an amino functional ethylenically unsaturated monomer. The anionic salt groups may be formed by incorporation of an acid functional unsaturated monomer and subsequent neutralization. For example, the polymeric dispersant may comprise an anionic salt group-containing polymeric dispersant comprising a polymerization product of a first stage ethylenically unsaturated monomer composition comprising an acid-functional ethylenically unsaturated monomer.

The first stage ethylenically unsaturated monomer composition may optionally comprise an epoxide functional monomer. The epoxide functional monomer allows for the incorporation of epoxide functional groups into the polymeric dispersant. The epoxide functional groups may be converted to cationic salt groups via reaction of the epoxide functional group with an amine and neutralization with acid. Examples of suitable epoxide functional monomers include glycidyl acrylate, glycidyl methacrylate, 3,4-epoxycyclohexylmethyl(meth)acrylate, 2-(3,4-epoxycyclohexyl)ethyl(meth)acrylate, or allyl glycidyl ether. The epoxide functional monomer may be present in an amount of at least 5% by weight, such as at least 10% by weight, such as at least 20% by weight, based on the total weight of the first stage ethylenically unsaturated monomer composition. The epoxide functional monomer may be present in an amount of no more than 50% by weight, such as no more than 40% by weight, such as no more than 30% by weight, such as no more than 25% by weight, such as no more than 20% by weight, based on the total weight of the first stage ethylenically unsaturated monomer composition. The epoxide functional monomer may be present in an amount of 5% to 50% by weight, such as 5% to 40% by weight, such as 5% to 30% by weight, such as 5% to 25% by weight, such as 5% to 20% by weight, such as 10% to 50% by weight, such as 10% to 40% by weight, such as 10% to 30% by weight, such as 10% to 25% by weight, such as 10% to 20% by weight, such as 20% to 50% by weight, such as 20% to 40% by weight, such as 20% to 30% by weight, such as 20% to 25% by weight, based on the total weight of the first stage ethylenically unsaturated monomer composition.

The first stage ethylenically unsaturated monomer composition may optionally comprise an amino functional monomer. The amino functional monomer allows for the incorporation of amino functional groups into the polymeric dispersant. The amino functional groups may be converted to cationic salt groups by neutralization with acid. The amino functional monomer may comprise any suitable amino functional unsaturated monomer, such as, for example, a N-alkylamino alkyl(meth)acrylate, a N,N-(dialkyl)amino alkyl(meth)acrylate, an amino alkyl(meth)acrylate, or the like. Specific non-limiting examples of suitable amino functional monomers include 2-aminoethyl (meth)acrylate, 2-(dimethylamino)ethylmethacrylate (“DMAEMA”), 2-(dimethylamino)ethyl acrylate, 3-(dimethylamino)propyl (meth)acrylate, 2-(diethylamino)ethyl (meth)acrylate, 2-(tert-butylamino)ethyl (meth)acrylate, and 2-(diethylamino)ethyl (meth)acrylate, as well as combinations thereof. The amino functional monomer may be present in an amount of at least 5% by weight, such as at least 10% by weight, such as at least 20% by weight, based on the total weight of the first stage ethylenically unsaturated monomer composition. The amino functional monomer may be present in an amount of no more than 50% by weight, such as no more than 40% by weight, such as no more than 30% by weight, such as no more than 25% by weight, such as no more than 20% by weight, based on the total weight of the first stage ethylenically unsaturated monomer composition. The amino functional monomer may be present in an amount of 5% to 50% by weight, such as 5% to 40% by weight, such as 5% to 30% by weight, such as 5% to 25% by weight, such as 5% to 20% by weight, such as 10% to 50% by weight, such as 10% to 40% by weight, such as 10% to 30% by weight, such as 10% to 25% by weight, such as 10% to 20% by weight, such as 20% to 50% by weight, such as 20% to 40% by weight, such as 20% to 30% by weight, such as 20% to 25% by weight, based on the total weight of the first stage ethylenically unsaturated monomer composition.

The first stage ethylenically unsaturated monomer composition may optionally comprise an acid-functional ethylenically unsaturated monomer. The acid-functional monomer allows for the incorporation of anionic salt groups into the polymeric dispersant by neutralization with a base. The acid-functional ethylenically unsaturated monomer may comprise phosphoric acid or carboxylic acid functional ethylenically unsaturated monomers, such as, for example, (meth)acrylic acid. The acid functional monomer may be present in the first stage ethylenically unsaturated monomer composition in an amount of at least 5% by weight, such as at least 10% by weight, such as at least 20% by weight, based on the total weight of the first stage ethylenically unsaturated monomer composition. The acid functional monomer may be present in the first stage ethylenically unsaturated monomer composition in an amount of no more than 50% by weight, such as no more than 40% by weight, such as no more than 30% by weight, such as no more than 25% by weight, such as no more than 20% by weight, based on the total weight of the first stage ethylenically unsaturated monomer composition. The acid functional monomer may be present in the first stage ethylenically unsaturated monomer composition in an amount of 5% to 50% by weight, such as 5% to 40% by weight, such as 5% to 30% by weight, such as 5% to 25% by weight, such as 5% to 20% by weight, such as 10% to 50% by weight, such as 10% to 40% by weight, such as 10% to 30% by weight, such as 10% to 25% by weight, such as 10% to 20% by weight, such as 20% to 50% by weight, such as 20% to 40% by weight, such as 20% to 30% by weight, such as 20% to 25% by weight, based on the total weight of the first stage ethylenically unsaturated monomer composition.

The first stage ethylenically unsaturated monomer composition optionally may further comprise at least one of a C₁-C₁₈ alkyl (meth)acrylate; a first stage hydroxyl-functional (meth)acrylate; a vinyl aromatic compound; and/or a monomer comprising two or more ethylenically unsaturated groups per molecule.

The first stage ethylenically unsaturated monomer composition optionally may further comprise monoolefinic aliphatic compounds such as C₁-C₁₈ alkyl (meth)acrylates. Examples of suitable C₁-C₁₈ alkyl (meth)acrylates include, without limitation, methyl (meth)acrylate, ethyl (meth)acrylate, butyl (meth)acrylate, hexyl (meth)acrylate, octyl (meth)acrylate, isodecyl (meth)acrylate, stearyl (meth)acrylate, 2-ethylhexyl (meth)acrylate, isobornyl (meth)acrylate, t-butyl (meth)acrylate, and the like. The C₁-C₁₈ alkyl (meth)acrylates may be present in the first stage ethylenically unsaturated monomer composition in an amount of at least 30% by weight, such as at least 40% by weight, such as at least 50% by weight, such as at least 60% by weight, such as at least 70% by weight, based on the total weight of the first stage ethylenically unsaturated monomer composition. The C₁-C₁₈ alkyl (meth)acrylates may be present in the first stage ethylenically unsaturated monomer composition in an amount of no more than 90% by weight, such as no more than 80% by weight, such as no more than 70% by weight, such as no more than 60% by weight, based on the total weight of the first stage ethylenically unsaturated monomer composition. The C₁-C₁₈ alkyl (meth)acrylates may be present in the first stage ethylenically unsaturated monomer composition in an amount of 30% to 90% by weight, such as 30% to 80% by weight, such as 30% to 70% by weight, such as 30% to 60% by weight, such as 40% to 90% by weight, such as 40% to 80% by weight, such as 40% to 70% by weight, such as 40% to 60% by weight, such as 50% to 90% by weight, such as 50% to 80% by weight, such as 50% to 70% by weight, such as 50% to 60% by weight, such as 60% to 90% by weight, such as 60% to 80% by weight, such as 60% to 70% by weight, such as 70% to 90% by weight, such as 70% to 80% by weight, based on the total weight of the first stage ethylenically unsaturated monomer composition. As used herein, “(meth)acrylate” and like terms encompasses both acrylates and methacrylates.

The ethylenically unsaturated monomer composition optionally may comprise a hydroxyl-functional (meth)acrylate. As used herein the term “hydroxyl-functional (meth)acrylate” collectively refers both acrylates and methacrylates, which have hydroxyl functionality, i.e., comprise at least one hydroxyl functional group in the molecule. The hydroxyl-functional (meth)acrylate may comprise a hydroxyalkyl (meth)acrylate, such as, for example, hydroxymethyl (meth)acrylate, hydroxyethyl (meth)acrylate, hydroxypropyl (meth)acrylate, hydroxybutyl (meth)acrylate, hydroxypentyl (meth)acrylate, and the like, as well as combinations thereof. The hydroxyl-functional (meth)acrylate may be present in the first stage ethylenically unsaturated monomer composition in an amount of at least 1% by weight, such as at least 5% by weight, such as at least 10% by weight, based on the total weight of the first stage ethylenically unsaturated monomer composition. The hydroxyl-functional (meth)acrylate may be present in the first stage ethylenically unsaturated monomer composition in an amount of no more than 40% by weight, such as no more than 30% by weight, such as no more than 25% by weight, such as no more than 15% by weight, based on the total weight of the first stage ethylenically unsaturated monomer composition. The hydroxyl-functional (meth)acrylate may be present in the first stage ethylenically unsaturated monomer composition in an amount of 1% to 40% by weight, such as 1% to 30% by weight, such as 1% to 25% by weight, such as 1% to 15% by weight, such as 5% to 40% by weight, such as 5% to 30% by weight, such as 5% to 25% by weight, such as 5% to 15% by weight, such as 10% to 40% by weight, such as 10% to 30% by weight, such as 10% to 25% by weight, such as 10% to 15% by weight, based on the total weight of the first stage ethylenically unsaturated monomer composition.

The first stage ethylenically unsaturated monomer composition may comprise a vinyl aromatic compound. Non-limiting examples of suitable vinyl aromatic compounds include styrene, alpha-methyl styrene, alpha-chloromethyl styrene and/or vinyl toluene. The vinyl aromatic compound may be present in the first stage ethylenically unsaturated monomer composition in an amount of at least 0.5% by weight, such as at least 1% by weight, such as at least 5% by weight, such as at least 10% by weight, based on the total weight of the first stage ethylenically unsaturated monomer composition. The vinyl aromatic compound may be present in the first stage ethylenically unsaturated monomer composition in an amount of no more than 40% by weight, such as no more than 30% by weight, such as no more than 20% by weight, such as no more than 15% by weight, such as no more than 10% by weight, based on the total weight of the first stage ethylenically unsaturated monomer composition. The vinyl aromatic compound may be present in the first stage ethylenically unsaturated monomer composition in an amount of 0.5% to 40% by weight, such as 0.5% to 30% by weight, such as 0.5% to 20% by weight, such as 0.5% to 15% by weight, such as 0.5% to 10% by weight, such as 1% to 40% by weight, such as 1% to 30% by weight, such as 1% to 20% by weight, such as 1% to 15% by weight, such as 1% to 10% by weight, such as 5% to 40% by weight, such as 5% to 30% by weight, such as 5% to 20% by weight, such as 5% to 15% by weight, such as 5% to 10% by weight, such as 10% to 40% by weight, such as 10% to 30% by weight, such as 10% to 20% by weight, such as 10% to 15% by weight, based on the total weight of the first stage ethylenically unsaturated monomer composition.

The first stage ethylenically unsaturated monomer composition optionally may comprise a monomer comprising two or more ethylenically unsaturated groups per molecule. The monomer comprising two or more ethylenically unsaturated groups per molecule may comprise a monomer having two ethylenically unsaturated groups per molecule. Examples of suitable monomers having two ethylenically unsaturated groups per molecule include ethylene glycol dimethacrylate, allyl methacrylate, hexanediol diacrylate, methacrylic anhydride, tetraethylene glycol diacrylate, and/or tripropylene glycol diacrylate. Examples of monomers having three or more ethylenically unsaturated groups per molecule include ethoxylated trimethylolpropane triacrylate having 0 to 20 ethoxy units, [ethoxylated] trimethylolpropane trimethacrylate having 0 to 20 ethoxy units, di-pentaerythritoltriacrylate, pentaerythritol tetraacrylate, and/or di-pentaerythritolpentaacrylate. The monomer comprising two or more ethylenically unsaturated groups per molecule may be present in the first stage ethylenically unsaturated monomer composition in an amount of at least 0.1% by weight, such as at least 1% by weight, such as at least 3% by weight, such as at least 5% by weight, based on the total weight of the first stage ethylenically unsaturated monomer composition. The monomer comprising two or more ethylenically unsaturated groups per molecule may be present in the first stage ethylenically unsaturated monomer composition in an amount of no more than 10% by weight, such as no more than 5% by weight, such as no more than 3% by weight, based on the total weight of the first stage ethylenically unsaturated monomer composition. The monomer comprising two or more ethylenically unsaturated groups per molecule may be present in the first stage ethylenically unsaturated monomer composition in an amount of 0.1% to 10% by weight, such as 0.1% to 5% by weight, such as 0.1% to 3% by weight, such as 1% to 10% by weight, such as 1% to 5% by weight, such as 1% to 3% by weight, such as 3% to 10% by weight, such as 3% to 5% by weight, such as 5% to 10% by weight, based on the total weight of the first stage ethylenically unsaturated monomer composition. The use of a monomer comprising two or more ethylenically unsaturated groups per molecule in the first stage ethylenically unsaturated monomer composition may result in a polymeric dispersant comprising ethylenically unsaturated groups. Accordingly, the polymeric dispersant may comprise ethylenically unsaturated groups.

The first stage ethylenically unsaturated monomer composition may comprise a first stage (meth)acrylamide monomer. As used herein, the term “first stage” with respect to a monomer, such as the (meth)acrylamide monomers, is intended to refer to a monomer used during the polymerization of the polymeric dispersant, and the resulting polymeric dispersant comprises the residue thereof. As used herein, the term “(meth)acrylamide” and like terms encompasses both acrylamides and methacrylamides. The first stage (meth)acrylamide monomers may comprise any suitable (meth)acrylamide monomer such as, for example, (meth)acrylamide, substituted or unsubstituted monoalkyl (meth)acrylamide monomers, or substituted or unsubstituted dialkyl (meth)acrylamide monomers. Non-limiting examples of the first stage (meth)acrylamide monomers include (meth)acrylamide, a C₁-C₁₈ alkyl (meth)acrylamide monomer, a hydroxyl-functional (meth)acrylamide monomer, and the like.

The first stage (meth)acrylamide monomers of the first stage ethylenically unsaturated monomer composition optionally may comprise a C₁-C₁₈ alkyl (meth)acrylamide monomer. Examples of suitable C₁-C₁₈ alkyl (meth)acrylamide monomers include, without limitation, methyl (meth)acrylamide, ethyl (meth)acrylamide, butyl (meth)acrylamide, hexyl (meth)acrylamide, octyl (meth)acrylamide, isodecyl (meth)acrylamide, stearyl (meth)acrylamide, 2-ethylhexyl (meth)acrylamide, isobornyl (meth)acrylamide, t-butyl (meth)acrylamide, and the like. The C₁-C₁₈ alkyl (meth)acrylamide monomer may be present in the first stage ethylenically unsaturated monomer composition in an amount of at least 30% by weight, such as at least 40% by weight, such as at least 50% by weight, such as at least 60% by weight, such as at least 70% by weight, based on the total weight of the first stage ethylenically unsaturated monomer composition. The C₁-C₁₈ alkyl (meth)acrylamide monomer may be present in the first stage ethylenically unsaturated monomer composition in an amount of no more than 90% by weight, such as no more than 80% by weight, such as no more than 70% by weight, such as no more than 60% by weight, based on the total weight of the first stage ethylenically unsaturated monomer composition. The C₁-C₁₈ alkyl (meth)acrylamide monomer may be present in the first stage ethylenically unsaturated monomer composition in an amount of 30% to 90% by weight, such as 30% to 80% by weight, such as 30% to 70% by weight, such as 30% to 60% by weight, such as 40% to 90% by weight, such as 40% to 80% by weight, such as 40% to 70% by weight, such as 40% to 60% by weight, such as 50% to 90% by weight, such as 50% to 80% by weight, such as 50% to 70% by weight, such as 50% to 60% by weight, such as 60% to 90% by weight, such as 60% to 80% by weight, such as 60% to 70% by weight, such as 70% to 90% by weight, such as 70% to 80% by weight, based on the total weight of the first stage ethylenically unsaturated monomer composition.

The ethylenically unsaturated monomer composition optionally may comprise a first stage hydroxyl-functional (meth)acrylamide monomer. As used herein the term “hydroxyl-functional (meth)acrylamide” collectively refers both acrylamides and methacrylamides, which have hydroxyl functionality, i.e., comprise at least one hydroxyl functional group in the molecule. The first stage hydroxyl-functional (meth)acrylamide monomer may comprise a hydroxyalkyl (meth)acrylamide, such as, for example, hydroxymethyl (meth)acrylamide, hydroxyethyl (meth)acrylamide, hydroxypropyl (meth)acrylamide, 2-hydroxypropyl (meth)acrylamide, hydroxybutyl (meth)acrylamide, hydroxypentyl (meth)acrylamide, and the like, as well as combinations thereof. The first stage hydroxyl-functional (meth)acrylamide monomer may be present in the first stage ethylenically unsaturated monomer composition in an amount of at least 1% by weight, such as at least 5% by weight, such as at least 10% by weight, based on the total weight of the first stage ethylenically unsaturated monomer composition. The first stage hydroxyl-functional (meth)acrylamide monomer may be present in the first stage ethylenically unsaturated monomer composition in an amount of no more than 40% by weight, such as no more than 30% by weight, such as no more than 25% by weight, such as no more than 15% by weight, based on the total weight of the first stage ethylenically unsaturated monomer composition. The first stage hydroxyl-functional (meth)acrylamide monomer may be present in the first stage ethylenically unsaturated monomer composition in an amount of 1% to 40% by weight, such as 1% to 30% by weight, such as 1% to 25% by weight, such as 1% to 15% by weight, such as 5% to 40% by weight, such as 5% to 30% by weight, such as 5% to 25% by weight, such as 5% to 15% by weight, such as 10% to 40% by weight, such as 10% to 30% by weight, such as 10% to 25% by weight, such as 10% to 15% by weight, based on the total weight of the first stage ethylenically unsaturated monomer composition.

The first stage ethylenically unsaturated monomer composition may comprise, consist essentially of, or consist of an epoxide functional ethylenically unsaturated monomer, and may optionally further comprise, consist essentially of, or consist of at least one of an amino functional unsaturated monomer, a C₁-C₁₈ alkyl (meth)acrylate, a hydroxyl-functional (meth)acrylate, a vinyl aromatic compound, and a monomer comprising two or more ethylenically unsaturated groups per molecule. Accordingly, the polymeric dispersant may comprise, consist essentially of, or consist of the residue of an epoxide functional ethylenically unsaturated monomer, and may optionally further comprise, consist essentially of, or consist of the residue of at least one of an amino functional unsaturated monomer, a C₁-C₁₈ alkyl (meth)acrylate, a hydroxyl-functional (meth)acrylate, a vinyl aromatic compound, an epoxide functional ethylenically unsaturated monomer, and/or a monomer comprising two or more ethylenically unsaturated groups per molecule. The polymeric dispersant may further comprise any amine incorporated into the polymeric dispersant through reaction with an epoxide functional group.

The first stage ethylenically unsaturated monomer composition may comprise, consist essentially of, or consist of an amino functional unsaturated monomer, and may further comprise, consist essentially of, or consist of at least one of a C₁-C₁₈ alkyl (meth)acrylate, a hydroxyl-functional (meth)acrylate, a vinyl aromatic compound, an epoxide functional ethylenically unsaturated monomer, and/or a monomer comprising two or more ethylenically unsaturated groups per molecule. Accordingly, the polymeric dispersant may comprise, consist essentially of, or consist of the residue of an amino functional unsaturated monomer, and may further comprise, consist essentially of, or consist of the residue of at least one of a C₁-C₁₈ alkyl (meth)acrylate, a hydroxyl-functional (meth)acrylate, a vinyl aromatic compound, an epoxide functional ethylenically unsaturated monomer, and/or a monomer comprising two or more ethylenically unsaturated groups per molecule. The polymeric dispersant may further comprise any amine incorporated into the polymeric dispersant through reaction with an epoxide functional group (if present).

The first stage ethylenically unsaturated monomer composition may comprise, consist essentially of, or consist of an acid-functional ethylenically unsaturated monomer, and may optionally further comprise, consist essentially of, or consist of at least one of a C₁-C₁₈ alkyl (meth)acrylate, a hydroxyl-functional (meth)acrylate, a vinyl aromatic compound, and/or a monomer comprising two or more ethylenically unsaturated groups per molecule. Accordingly, the polymeric dispersant may comprise, consist essentially of, or consist of the residue of an acid-functional ethylenically unsaturated monomer, and may optionally further comprise, consist essentially of, or consist of the residue of at least one of a C₁-C₁₈ alkyl (meth)acrylate, a hydroxyl-functional (meth)acrylate, a vinyl aromatic compound, an acid-functional ethylenically unsaturated monomer, and/or a monomer comprising two or more ethylenically unsaturated groups per molecule.

The polymeric dispersant may be prepared in organic solution by techniques well known in the art. For example, the polymeric dispersant may be prepared by conventional free radical initiated solution polymerization techniques wherein the first stage ethylenically unsaturated monomer composition is dissolved in a solvent or a mixture of solvents and polymerized in the presence of a free radical initiator. Examples of suitable solvents which may be used for organic solution polymerization include alcohols, such as ethanol, tertiary butanol, and tertiary amyl alcohol; ketones, such as acetone, methyl ethyl ketone; and ethers, such as dimethyl ether of ethylene glycol. Examples of suitable free radical initiators include those which are soluble in the mixture of monomers, such as azobisisobutyronitrile, 2,2′-azobis(2-methylbutyronitrile), azobis-(alpha, gamma-dimethylvaleronitrile), tertiary-butyl perbenzoate, tertiary-butyl peracetate, benzoyl peroxide, and ditertiary-butyl peroxide. The free radical initiator may be present in an amount of 0.01% to 6% by weight, such as 1.0% to 4.0% by weight, such as 2.0% to 3.5% by weight, based on the total weight of the first stage ethylenically unsaturated monomer composition. In examples, the solvent may be first heated to reflux and a mixture of the first stage ethylenically unsaturated monomer composition and a free radical initiator may be added slowly to the refluxing solvent. The reaction mixture may be held at polymerizing temperatures so as to reduce the free monomer content to below 1.0%, such as below 0.5% by weight, based on the total weight of the first stage ethylenically unsaturated monomer composition. Suitable specific conditions for forming such polymers include those set forth in the Examples section of the present application.

A chain transfer agent may be used in the synthesis of the polymeric dispersant, such as those that are soluble in the mixture of monomers. Suitable non-limiting examples of such agents include alkyl mercaptans, for example, tertiary-dodecyl mercaptan; ketones, such as methyl ethyl ketone; and chlorohydrocarbons, such as chloroform.

The polymeric dispersant may have a z-average molecular weight (Mt) of at least 200,000 g/mol, such as at least 250,000 g/mol, such as at least 300,000 g/mol, and may be no more than 2,000,000 g/mol, such as no more than 1,200,000 g/mol, such as no more than 900,000. The polymeric dispersant may have a z-average molecular weight (Mt) of 200,000 g/mol to 2,000,000 g/mol, such as 200,000 g/mol to 1,200,000 g/mol, such as 200,000 g/mol to 900,000 g/mol, such as 250,000 g/mol to 2,000,000 g/mol, such as 250,000 g/mol to 1,200,000 g/mol, such as 250,000 g/mol to 900,000 g/mol, such as 300,000 to 2,000,000 g/mol, such as 300,000 g/mol to 1,200,000 g/mol, such as 300,000 g/mol to 900,000 g/mol.

According to the present disclosure, the polymeric dispersant may have a weight average molecular weight (Mw) of at least 150,000 g/mol, such as at least 175,000 g/mol, such as at least 200,000 g/mol, and may have a weight average molecular weight of no more than 750,000 g/mol, such as no more than 400,000 g/mol, such as no more than 300,000 g/mol. According to the present disclosure, the polymeric dispersant may have a weight average molecular weight of 150,000 g/mol to 750,000 g/mol, such as 150,000 g/mol to 400,000 g/mol, such as 150,000 g/mol to 300,000 g/mol, such as 175,000 g/mol to 750,000 g/mol, such as 175,000 g/mol to 400,000 g/mol, such as 175,000 g/mol to 300,000 g/mol, such as 200,000 g/mol to 750,000 g/mol, such as 200,000 g/mol to 400,000 g/mol, such as 200,000 g/mol to 300,000 g/mol.

As used herein, unless otherwise stated, with respect to polymers having a z-average molecular weight (Mt) of less than 900,000, the terms “z-average molecular weight (M_{z})” and “weight average molecular weight (M_{w})” means the z-average molecular weight (M_{z}) and the weight average molecular weight (M_{w}) as determined by Gel Permeation Chromatography using Waters 2695 separation module with a Waters 410 differential refractometer (RI detector), polystyrene standards having molecular weights of from approximately 500 g/mol to 900,000 g/mol, dimethylformamide (DMF) with 0.05 M lithium bromide(LiBr) as the eluent at a flow rate of 0.5 mL/min, and one Asahipak GF-510 HQ column for separation. With respect to polymers having a z-average molecular weight (M_{z}) of greater than 900,000 g/mol, the term “z-average molecular weight (M_{z})” and “weight average molecular weight (M_{w})” means the z-average molecular weight (M_{z}) and the weight average molecular weight (M_{w}) as determined by Gel Permeation Chromatography (“GPC”) using Waters 2695 separation module with a Waters 410 differential refractometer (RI detector), polystyrene standards having molecular weights of from approximately 500 g/mol to 3,000,000 g/mol, dimethylformamide (DMF) with 0.05 M lithium bromide(LiBr) as the eluent at a flow rate of 0.5 mL/min, and one Asahipak GF-7M HQ column for separation.

Ionic groups in the polymeric dispersant may be formed by at least partially neutralizing basic or acidic groups present in the polymeric dispersant with an acid or base, respectively. The ionic groups in the polymeric molecules may be charge neutralized by counter-ions. Ionic groups and charge neutralizing counter-ions may together form salt groups, such that the polymeric dispersant comprises an ionic salt group-containing polymeric dispersant.

Accordingly, the polymeric dispersant may be, prior to or during dispersion in a dispersing medium comprising water, at least partially neutralized by, for example, treating with an acid to form a water-dispersible cationic salt group-containing polymeric dispersant. As used herein, the term “cationic salt group-containing polymeric dispersant” refers to a cationic polymeric dispersant comprising at least partially neutralized cationic functional groups, such as sulfonium groups and ammonium groups, that impart a positive charge. Non-limiting examples of suitable acids are inorganic acids, such as phosphoric acid and sulfamic acid, as well as organic acids, such as, acetic acid and lactic acid, among others. Besides acids, salts such as dimethylhydroxyethylammonium dihydrogenphosphate and ammonium dihydrogenphosphate may be used to at least partially neutralize the polymeric dispersant. The polymeric dispersant may be neutralized to the extent of at least 50%, such as at least 70% of the total theoretical neutralization equivalent. As used herein, the “total theoretical neutralization equivalent” refers to a percentage of the stoichiometric amount of acid to the total amount of basic groups, such as amino groups, theoretically present on the polymer. As discussed above, amines may be incorporated into the cationic polymeric dispersant by reaction of an amine with epoxide functional groups present in the polymeric dispersant. The step of dispersion may be accomplished by combining the neutralized or partially neutralized cationic salt group-containing polymeric dispersant with the dispersing medium of the dispersing phase. Neutralization and dispersion may also be accomplished in one step by combining the polymeric dispersant and the dispersing medium. The polymeric dispersant (or its salt) may be added to the dispersing medium, or the dispersing medium may be added to the polymeric dispersant (or its salt). The pH of the dispersion may be within the range of 5 to 9.

The cationic salt group-containing polymeric dispersant may comprise a sufficient cationic salt group content to stabilize a subsequent polymerization of a second stage ethylenically unsaturated monomer composition (described below) and to provide for a resulting addition polymer that is stable in a cationic electrodepositable coating composition. Also, the cationic salt group-containing polymeric dispersant may have sufficient cationic salt group content so that, when used with the other film-forming resins in the cationic electrodepositable coating composition, the composition upon being subjected to electrodeposition conditions will deposit as a coating on the substrate. The cationic salt group-containing polymeric dispersant may comprise, for example, 0.1 to 5.0, such as 0.3 to 1.1 milliequivalents of cationic salt groups per gram of cationic salt group-containing polymeric dispersant.

According to the present disclosure, the polymeric dispersant may be, prior to or during dispersion in a dispersing medium comprising water, at least partially neutralized by, for example, treating with a base to form a water-dispersible anionic salt group-containing polymeric dispersant. As used herein, the term “anionic salt group-containing polymeric dispersant” refers to an anionic polymeric dispersant comprising at least partially neutralized anionic functional groups, such as carboxylic acid and phosphoric acid groups, that impart a negative charge. Non-limiting examples of suitable bases are amines, such as, for example, tertiary amines. Specific examples of suitable amines include, but are not limited to, trialkylamines and dialkylalkoxyamines, such as triethylamine, diethylethanol amine and dimethylethanolamine The polymeric dispersant may be neutralized to the extent of at least 50 percent or, in some cases, at least 70 percent, or, in other cases 100 percent or more, of the total theoretical neutralization equivalent. The step of dispersion may be accomplished by combining the neutralized or partially neutralized anionic salt group-containing polymeric dispersant with the dispersing medium of the dispersing phase. Neutralization and dispersion may be accomplished in one step by combining the polymeric dispersant and the dispersing medium. The polymeric dispersant (or its salt) may be added to the dispersing medium, or the dispersing medium may be added to the polymeric dispersant (or its salt). The pH of the dispersion may be within the range of 5 to 9.

The anionic salt group-containing polymeric dispersant may comprise a sufficient anionic salt group content to stabilize a subsequent polymerization of a second stage ethylenically unsaturated monomer composition (described below) and to provide for a resulting addition polymer that is stable in an anionic electrodepositable coating composition. Also, the anionic salt group-containing polymeric dispersant may have sufficient anionic salt group content so that, when used with the other film-forming resins in the anionic electrodepositable coating composition, the composition upon being subjected to anionic electrodeposition conditions will deposit as a coating on the substrate. The anionic salt group-containing polymeric dispersant may contain from 0.1 to 5.0, such as 0.3 to 1.1 milliequivalents of anionic salt groups per gram of anionic salt group-containing polymeric dispersant.

According to the present disclosure, the second stage ethylenically unsaturated monomer composition comprises, consists essentially of, or consists of one or more second stage (meth)acrylamide monomers. As used herein, the term “second stage” with respect to a monomer, such as the (meth)acrylamide monomers, is intended to refer to a monomer used during any subsequent polymerization step of the addition polymer that is polymerized in the presence of the pre-formed polymeric dispersant, and the resulting addition polymer comprises the residue thereof. The (meth)acrylamide monomers may comprise any suitable (meth)acrylamide monomer such as, for example, (meth)acrylamide, substituted or unsubstituted monoalkyl (meth)acrylamides, or substituted or unsubstituted dialkyl (meth)acrylamides. Non-limiting examples include (meth)acrylamide, a C₁-C₁₈ alkyl (meth)acrylamide, a hydroxyl-functional (meth)acrylamide, and the like.

The second stage ethylenically unsaturated monomer composition may comprise, consist essentially of, or consist of (meth)acrylamide, such as (meth)acrylamide or acrylamide. The (meth)acrylamide monomer may be present in the second stage ethylenically unsaturated monomer composition in an amount of at least 20% by weight, such as at least 30% by weight, such as at least 40% by weight, such as at least 50% by weight, such as at least 60% by weight, such as at least 70% by weight, such at least 80% by weight, such as at least 90% by weight, such as at least 95% by weight, such as at least 99% by weight, such as 100% by weight, based on the total weight of the second stage ethylenically unsaturated monomer composition. The (meth)acrylamide monomer may be present in the second stage ethylenically unsaturated monomer composition in an amount of no more than 99% by weight, such as no more than 90% by weight, such as no more than 80% by weight, such as no more than 70% by weight, such as no more than 60% by weight, such as no more than 50% by weight, based on the total weight of the second stage ethylenically unsaturated monomer composition. The (meth)acrylamide monomer may be present in the second stage ethylenically unsaturated monomer composition in an amount of 20% to 100% by weight, such as 20% to 99% by weight, such as 20% to 90% by weight, such as 20% to 80% by weight, such as 20% to 70% by weight, such as 20% to 60% by weight, such as 20% to 50% by weight, such as 30% to 100% by weight, such as 30% to 99% by weight, such as 30% to 90% by weight, such as 30% to 80% by weight, such as 30% to 70% by weight, such as 30% to 60% by weight, such as 30% to 50% by weight, such as 40% to 100% by weight, such as 40% to 99% by weight, such as 40% to 90% by weight, such as 40% to 80% by weight, such as 40% to 70% by weight, such as 40% to 60% by weight, such as 40% to 50% by weight, such as 50% to 100% by weight, such as 50% to 99% by weight, such as 50% to 90% by weight, such as 50% to 80% by weight, such as 50% to 70% by weight, such as 50% to 60% by weight, such as 60% to 100% by weight, such as 60% to 99% by weight, such as 60% to 90% by weight, such as 60% to 80% by weight, such as 60% to 70% by weight, such as 70% to 100% by weight, such as 70% to 99% by weight, such as 70% to 90% by weight, such as 70% to 80% by weight, such as 80% to 100% by weight, such as 80% to 99% by weight, such as 80% to 90% by weight, such as 90% to 100% by weight, such as 90% to 99% by weight, such as 95% to 100% by weight, such as 95% to 99% by weight, such as 95% to 100% by weight, such as 95% to 99% by weight, based on the total weight of the second stage ethylenically unsaturated monomer composition.

The second stage ethylenically unsaturated monomer composition may comprise, consist essentially of, or consist of a second-stage hydroxyl-functional (meth)acrylamide monomer. The second-stage hydroxyl-functional (meth)acrylamide monomer may comprise a primary hydroxyl group. The second-stage hydroxyl-functional (meth)acrylamide monomer may comprise a secondary hydroxyl group. The second-stage hydroxyl-functional (meth)acrylamide monomer may comprise one or more of a C₁-C₉ hydroxyalkyl (meth)acrylamide, such as a C₁-C₆ hydroxyalkyl (meth)acrylamide, such as a C₁-C₅ hydroxyalkyl (meth)acrylamide such as, for example, hydroxymethyl (meth)acrylamide, hydroxyethyl (meth)acrylamide, hydroxypropyl (meth)acrylamide, 2-hydroxypropyl (meth)acrylamide, hydroxybutyl (meth)acrylamide, hydroxypentyl (meth)acrylamide, or any combination thereof.

The second-stage hydroxyl-functional (meth)acrylamide monomer may be present in the second stage ethylenically unsaturated monomer composition in an amount of at least 20% by weight, such as at least 30% by weight, such as at least 40% by weight, such as at least 50% by weight, such as at least 60% by weight, such as at least 70% by weight, such at least 80% by weight, such as at least 90% by weight, such as at least 95% by weight, such as at least 99% by weight, such as 100% by weight, based on the total weight of the second stage ethylenically unsaturated monomer composition. The second-stage hydroxyl-functional (meth)acrylamide monomer may be present in the second stage ethylenically unsaturated monomer composition in an amount of no more than 99% by weight, such as no more than 90% by weight, such as no more than 80% by weight, such as no more than 70% by weight, such as no more than 60% by weight, such as no more than 50% by weight, based on the total weight of the second stage ethylenically unsaturated monomer composition. The second-stage hydroxyl-functional (meth)acrylamide monomer may be present in the second stage ethylenically unsaturated monomer composition in an amount of 20% to 100% by weight, such as 20% to 99% by weight, such as 20% to 90% by weight, such as 20% to 80% by weight, such as 20% to 70% by weight, such as 20% to 60% by weight, such as 20% to 50% by weight, such as 30% to 100% by weight, such as 30% to 99% by weight, such as 30% to 90% by weight, such as 30% to 80% by weight, such as 30% to 70% by weight, such as 30% to 60% by weight, such as 30% to 50% by weight, such as 40% to 100% by weight, such as 40% to 99% by weight, such as 40% to 90% by weight, such as 40% to 80% by weight, such as 40% to 70% by weight, such as 40% to 60% by weight, such as 40% to 50% by weight, such as 50% to 100% by weight, such as 50% to 99% by weight, such as 50% to 90% by weight, such as 50% to 80% by weight, such as 50% to 70% by weight, such as 50% to 60% by weight, such as 60% to 100% by weight, such as 60% to 99% by weight, such as 60% to 90% by weight, such as 60% to 80% by weight, such as 60% to 70% by weight, such as 70% to 100% by weight, such as 70% to 99% by weight, such as 70% to 90% by weight, such as 70% to 80% by weight, such as 80% to 100% by weight, such as 80% to 99% by weight, such as 80% to 90% by weight, such as 90% to 100% by weight, such as 90% to 99% by weight, such as 95% to 100% by weight, such as 95% to 99% by weight, such as 95% to 100% by weight, such as 95% to 99% by weight, based on the total weight of the second stage ethylenically unsaturated monomer composition.

The second stage ethylenically unsaturated monomer composition may optionally further comprise a phosphorous acid-functional ethylenically unsaturated monomer. The phosphorous acid group may comprise a phosphonic acid group, a phosphinic acid group, or combinations thereof, as well as salts thereof. The phosphorous acid-functional ethylenically unsaturated monomer may be dihydrogen phosphate esters of an alcohol in which the alcohol contains or is substituted with a polymerizable vinyl or olefinic group. Suitable phosphorous acid-functional ethylenically unsaturated monomer may include phosphoalkyl (meth)acrylates such as phosphoethyl (meth)acrylate, phosphopropyl (meth)acrylate, phosphobutyl (meth)acrylate, salts of phosphoalkyl (meth)acrylates, and mixtures thereof; CH₂═C(R)—C(O)—O—(RₚO)ₙ—P(O)(OH)₂, wherein R═H or CH₃ and Rₚ=alkyl, n is from 1 to 20, such as SIPOMER PAM-100, SIPOMER PAM-200, SIPOMER PAM-300, and SIPOMER PAM-4000 all available from Solvay; phosphoalkoxy (meth)acrylates such as phospho ethylene glycol (meth)acrylate, phospho di-ethylene glycol (meth)acrylate, phospho tri-ethylene glycol (meth)acrylate, phospho propylene glycol (meth)acrylate, phospho dipropylene glycol (meth)acrylate, phospho tri-propylene glycol (meth)acrylate, salts thereof, and mixtures thereof. The phosphorous acid-functional ethylenically unsaturated monomer may be present in the second stage ethylenically unsaturated monomer composition in an amount of at least 0.1% by weight, such as at least 0.5% by weight, such as at least 1% by weight, such as at least 1.5% by weight, based on the total weight of the second stage ethylenically unsaturated monomer composition. The phosphorous acid-functional ethylenically unsaturated monomer may be present in the second stage ethylenically unsaturated monomer composition in an amount of no more than 20% by weight, such as no more than 10% by weight, such as no more than 4% by weight, such as no more than 2.5% by weight, based on the total weight of the second stage ethylenically unsaturated monomer composition. The phosphorous acid-functional ethylenically unsaturated monomer may be present in the second stage ethylenically unsaturated monomer composition in an amount of 0.1% to 20% by weight, such as 0.1% to 10% by weight, such as 0.1% to 4% by weight, such as 0.1% to 2.5% by weight, such as 0.5% to 20% by weight, such as 0.5% to 10% by weight, such as 0.5% to 4% by weight, such as 0.5% to 2.5% by weight, such as 1% to 20% by weight, such as 1% to 10% by weight, such as 1% to 4% by weight, such as 1% to 2.5% by weight, such as 1.5% to 20% by weight, such as 1.5% to 10% by weight, such as 1.5% to 4% by weight, such as 1.5% to 2.5% by weight, based on the total weight of the second stage ethylenically unsaturated monomer composition.

The second stage ethylenically unsaturated monomer composition may optionally comprise other ethylenically unsaturated monomers. The other ethylenically unsaturated monomers may comprise any ethylenically unsaturated monomers known in the art. Examples of other ethylenically unsaturated monomers that may be used in the second stage ethylenically unsaturated monomer composition include, without limitation, the monomers described above with respect to the preparation of the polymeric dispersant, as well as di(meth)acrylates and poly(ethylene glycol) (meth)acrylates. Such monomers may be present, if at all, in an amount of 1% to 80% by weight, such as 1% to 70% by weight, such as 1% to 60% by weight, such as 1% to 50% by weight, such as 1% to 40% by weight, such as 1% to 30% by weight, such as 1% to 20% by weight, such as 1% to 10% by weight, such as 1% to 5% by weight, such as 5% to 80% by weight, such as 5% to 70% by weight, such as 5% to 60% by weight, such as 5% to 50% by weight, such as 5% to 40% by weight, such as 5% to 30% by weight, such as 5% to 20% by weight, such as 5% to 10% by weight, such as 10% to 80% by weight, such as 10% to 70% by weight, such as 10% to 60% by weight, such as 10% to 50% by weight, such as 10% to 40% by weight, such as 10% to 30% by weight, such as 10% to 20% by weight, such as 20% to 80% by weight, such as 20% to 70% by weight, such as 20% to 60% by weight, such as 20% to 50% by weight, such as 20% to 40% by weight, such as 20% to 30% by weight, such as 30% to 80% by weight, such as 30% to 70% by weight, such as 30% to 60% by weight, such as 30% to 50% by weight, such as 30% to 40% by weight, based on the total weight of the second stage ethylenically unsaturated monomer composition.

According to the present disclosure, the addition polymer may comprise a polymerization product comprising at least 10% by weight of the residue of the polymeric dispersant, such as at least 20% by weight, such as at least 30% by weight, such as at least 40% by weight, such as at least 50% by weight, such as at least 60% by weight, such as at least 70% by weight, such as at least 80% by weight, the percent by weight being based on the total weight of the addition polymer. The addition polymer may comprise a polymerization product comprising no more than 90% by weight of the residue of the polymeric dispersant, such as no more than 80% by weight, such as no more than 70% by weight, such as no more than 60% by weight, such as no more than 50% by weight, such as no more than 40% by weight, such as no more than 30% by weight, such as no more than 20% by weight, the percent by weight being based on the total weight of the addition polymer. The addition polymer may comprise a polymerization product comprising 10% to 90% by weight of the residue of the polymeric dispersant, such as 10% to 80% by weight, such as 10% to 70% by weight, such as 10% to 60% by weight, such as 10% to 50% by weight, such as 10% to 40% by weight, such as 10% to 30% by weight, such as 10% to 20% by weight, such as 20% to 90% by weight, such as 20% to 80% by weight, such as 20% to 70% by weight, such as 20% to 60% by weight, such as 20% to 50% by weight, such as 20% to 40% by weight, such as 20% to 30% by weight, such as 30% to 90% by weight, such as 30% to 80% by weight, such as 30% to 70% by weight, such as 30% to 60% by weight, such as 30% to 50% by weight, such as 30% to 40% by weight, such as 40% to 90% by weight, such as 40% to 80% by weight, such as 40% to 70% by weight, such as 40% to 60% by weight, such as 40% to 50% by weight, such as 50% to 90% by weight, such as 50% to 80% by weight, such as 50% to 70% by weight, such as 50% to 60% by weight, such as 60% to 90% by weight, such as 60% to 80% by weight, such as 60% to 70% by weight, such as 70% to 90% by weight, such as 70% to 80% by weight, such as 80% to 90% by weight, the percent by weight being based on the total weight of the addition polymer.

According to the present disclosure, the addition polymer may comprise a polymerization product comprising at least 10% by weight of the residue of the second stage ethylenically unsaturated monomer composition, such as at least 20% by weight, such as at least 30% by weight, such as at least 40% by weight, such as at least 50% by weight, such as at least 60% by weight, such as at least 70% by weight, such as at least 80% by weight, the percent by weight being based on the total weight of the addition polymer. The addition polymer may comprise a polymerization product comprising no more than 90% by weight of the residue of the second stage ethylenically unsaturated monomer composition, such as no more than 80% by weight, such as no more than 70% by weight, such as no more than 60% by weight, such as no more than 50% by weight, such as no more than 40% by weight, such as no more than 30% by weight, such as no more than 20% by weight, the percent by weight being based on the total weight of the addition polymer. The addition polymer may comprise a polymerization product comprising 10% to 90% by weight of the residue of the second stage ethylenically unsaturated monomer composition, such as 10% to 80% by weight, such as 10% to 70% by weight, such as 10% to 60% by weight, such as 10% to 50% by weight, such as 10% to 40% by weight, such as 10% to 30% by weight, such as 10% to 20% by weight, such as 20% to 90% by weight, such as 20% to 80% by weight, such as 20% to 70% by weight, such as 20% to 60% by weight, such as 20% to 50% by weight, such as 20% to 40% by weight, such as 20% to 30% by weight, such as 30% to 90% by weight, such as 30% to 80% by weight, such as 30% to 70% by weight, such as 30% to 60% by weight, such as 30% to 50% by weight, such as 30% to 40% by weight, such as 40% to 90% by weight, such as 40% to 80% by weight, such as 40% to 70% by weight, such as 40% to 60% by weight, such as 40% to 50% by weight, such as 50% to 90% by weight, such as 50% to 80% by weight, such as 50% to 70% by weight, such as 50% to 60% by weight, such as 60% to 90% by weight, such as 60% to 80% by weight, such as 60% to 70% by weight, such as 70% to 90% by weight, such as 70% to 80% by weight, such as 80% to 90% by weight, the percent by weight being based on the total weight of the addition polymer.

According to the present disclosure, the addition polymer may comprise a polymerization product of the polymeric dispersant and the second stage ethylenically unsaturated monomer composition wherein the weight ratio of the second stage ethylenically unsaturated monomer composition to the polymeric dispersant may be 9:1 to 1:9, such as 9:1 to 1:4, such as 9:1 to 3:7, such as 9:1 to 2:3, such as 9:1 to 1:1, such as 9:1 to 3:2, such as 9:1 to 7:3, such as 9:1 to 4:1, such as 4:1 to 1:9, such as 4:1 to 1:4, such as 4:1 to 3:7, such as 4:1 to 2:3, such as 4:1 to 1:1, such as 4:1 to 3:2, such as 4:1 to 7:3, such as 4:1 to 9:1, such as 7:3 to 1:9, such as 7:3 to 1:4, such as 7:3 to 3:7, such as 7:3 to 2:3, such as 7:3 to 1:1, such as 7:3 to 3:2, such as 7:3 to 4:1, such as 7:3 to 9:1, such as 3:2 to 1:9, such as 3:2 to 1:4, such as 3:2 to 3:7, such as 3:2 to 2:3, such as 3:2 to 1:1, such as 3:2 to 7:3, such as 3:2 to 4:1, such as 3:2 to 9:1, such as 1:1 to 1:9, such as 1:1 to 1:4, such as 1:1 to 3:7, such as 1:1 to 2:3, such as 1:1 to 3:2, such as 1:1 to 7:3, such as 1:1 to 4:1, such as 1:1 to 9:1, such as 2:3 to 1:9, such as 2:3 to 1:4, such as 2:3 to 3:7, such as 2:3 to 1:1, such as 2:3 to 3:2, such as 9:1 to 7:3, such as 2:3 to 4:1, such as 2:3 to 9:1, such as 3:7 to 1:9, such as 3:7 to 1:4, such as 3:7 to 2:3, such as 3:7 to 1:1, such as 3:7 to 3:2, such as 3:7 to 7:3, such as 3:7 to 4:1, such as 3:7 to 9:1, such as 1:4 to 1:9, such as 1.4 to 3:7, such as 1.4 to 2:3, such as 1.4 to 1:1, such as 1.4 to 3:2, such as 1.4 to 7:3, such as 1.4 to 4:1, such as 1:4 to 9:1, such as 1:9 to 1:4, such as 1:9 to 3:7, such as 1:9 to 2:3, such as 1:9 to 1:1, such as 1:9 to 3:2, such as 1:9 to 7:3, such as 1:9 to 4:1, such as 1:9 to 9:1.

The addition polymer may comprise a polymerization product of the polymeric dispersant and the second stage ethylenically unsaturated monomer composition wherein the weight ratio of the residue of the second stage ethylenically unsaturated monomer composition to the residue of the polymeric dispersant may be 9:1 to 1:9, such as 9:1 to 1:4, such as 9:1 to 3:7, such as 9:1 to 2:3, such as 9:1 to 1:1, such as 9:1 to 3:2, such as 9:1 to 7:3, such as 9:1 to 4:1, such as 4:1 to 1:9, such as 4:1 to 1:4, such as 4:1 to 3:7, such as 4:1 to 2:3, such as 4:1 to 1:1, such as 4:1 to 3:2, such as 4:1 to 7:3, such as 4:1 to 9:1, such as 7:3 to 1:9, such as 7:3 to 1:4, such as 7:3 to 3:7, such as 7:3 to 2:3, such as 7:3 to 1:1, such as 7:3 to 3:2, such as 7:3 to 4:1, such as 7:3 to 9:1, such as 3:2 to 1:9, such as 3:2 to 1:4, such as 3:2 to 3:7, such as 3:2 to 2:3, such as 3:2 to 1:1, such as 3:2 to 7:3, such as 3:2 to 4:1, such as 3:2 to 9:1, such as 1:1 to 1:9, such as 1:1 to 1:4, such as 1:1 to 3:7, such as 1:1 to 2:3, such as 1:1 to 3:2, such as 1:1 to 7:3, such as 1:1 to 4:1, such as 1:1 to 9:1, such as 2:3 to 1:9, such as 2:3 to 1:4, such as 2:3 to 3:7, such as 2:3 to 1:1, such as 2:3 to 3:2, such as 9:1 to 7:3, such as 2:3 to 4:1, such as 2:3 to 9:1, such as 3:7 to 1:9, such as 3:7 to 1:4, such as 3:7 to 2:3, such as 3:7 to 1:1, such as 3:7 to 3:2, such as 3:7 to 7:3, such as 3:7 to 4:1, such as 3:7 to 9:1, such as 1:4 to 1:9, such as 1.4 to 3:7, such as 1.4 to 2:3, such as 1.4 to 1:1, such as 1.4 to 3:2, such as 1.4 to 7:3, such as 1.4 to 4:1, such as 1:4 to 9:1, such as 1:9 to 1:4, such as 1:9 to 3:7, such as 1:9 to 2:3, such as 1:9 to 1:1, such as 1:9 to 3:2, such as 1:9 to 7:3, such as 1:9 to 4:1, such as 1:9 to 9:1.

The addition polymer may comprise active hydrogen functional groups. As used herein, the term “active hydrogen functional groups” refers to those groups that are reactive with isocyanates as determined by the Zerewitnoff test as is described in the JOURNAL OF THE AMERICAN CHEMICAL SOCIETY, Vol. 49, page 3181 (1927). The active hydrogen functional groups may include hydroxyl groups, mercaptan groups, primary amine groups and/or secondary amine groups.

According to the present disclosure, the addition polymer may have a theoretical hydroxyl equivalent weight of at least 120 g/hydroxyl group (“OH”), such as at least 130 g/OH, such as at least 140 g/OH, such as at least 145 g/OH, and may be no more than 310 g/OH, such as no more than 275 g/OH, such as no more than 200 g/OH, such as no more than 160 g/OH. The addition polymer may have a theoretical hydroxyl equivalent weight of 120 g/OH to 310 g/OH, such as 130 g/OH to 275 g/OH, such as 140 g/OH to 200 g/OH, such as 145 g/OH to 160 g/OH. As used herein, the term “theoretical hydroxyl equivalent weight” refers to the weight in grams of addition polymer resin solids divided by the theoretical equivalents of hydroxyl groups present in the addition polymer resin, and may be calculated according to the following formula (1):

$$hydroxyl equivalent weight = \frac{total grtams addition polymer resin solds}{theoretical equivalents of OH} \qquad ( 1 )$$

According to the present disclosure, the addition polymer may have a theoretical hydroxyl value of at least 190 mg KOH/gram addition polymer, such as at least 250 mg KOH/gram addition polymer, such as at least 320 mg KOH/gram addition polymer, such as at least 355 mg KOH/gram addition polymer, and may be no more than 400 mg KOH/gram addition polymer, such as no more than 390 mg KOH/gram addition polymer, such as no more than 380 mg KOH/gram addition polymer, such as no more than 370 mg KOH/gram addition polymer. The addition polymer may have a theoretical hydroxyl value of 190 to 400 mg KOH/gram addition polymer, such as 250 to 390 mg KOH/gram addition polymer, such as 320 to 380 mg KOH/gram addition polymer, such as 355 to 370 mg KOH/gram addition polymer. As used herein, the term “theoretical hydroxyl value” typically refers to the number of milligrams of potassium hydroxide required to neutralize the acetic acid taken up on acetylation of one gram of a chemical substance that contains free hydroxyl groups and was herein determined by a theoretical calculation of the number of free hydroxyl groups theoretically present in one gram of the addition polymer.

According to the present disclosure, the addition polymer may have a z-average molecular weight (M t) of at least 500,000 g/mol, such as at least 750,000 g/mol such as at least 1,400,000 g/mol, such as at least 1,500,000 g/mol, such as at least 1,800,000 g/mol, and may have a z-average molecular weight of no more than 5,000,000 g/mol, such as no more than 2,600,000 g/mol, such as no more than 2,200,000 g/mol, such as no more than 1,700,000 g/mol, such as no more than 950,000 g/mol. According to the present disclosure, the addition polymer may have a z-average molecular weight of 500,000 g/mol to 5,000,000 g/mol, such as 1,400,000 g/mol to 2,600,000 g/mol, such as 1,800,000 g/mol to 2,200,000 g/mol, such as 1,500,000 g/mol to 1,700,000 g/mol, such as 750,000 g/mol to 950,000 g/mol. The z-average molecular weight may be measured by gel permeation chromatography using polystyrene standards by the same procedure as described above.

According to the present disclosure, the addition polymer may have a weight average molecular weight (M w) of at least 200,000 g/mol, such as at least 400,000 g/mol, such as at least 500,000 g/mol, and may have a weight average molecular weight of no more than 1,600,000 g/mol, such as no more than 900,000 g/mol, such as no more than 800,000 g/mol. According to the present disclosure, the addition polymer may have a weight average molecular weight of 200,000 g/mol to 1,600,000 g/mol, such as 400,000 g/mol to 900,000 g/mol, such as 500,000 g/mol to 800,000 g/mol. The weight average molecular weight may be measured by gel permeation chromatography using polystyrene standards by the same procedure as described above.

According to the present disclosure, the addition polymer may be substantially free, essentially free, or completely free of silicon. As used herein, “silicon” refers to elemental silicon or any silicon containing compound, such as an organosilicon compound including an alkoxysilane. As used herein, the addition polymer is “substantially free” of silicon if silicon is present in the addition polymer in an amount of less than 2% by weight, based on the total weight of the addition polymer. As used herein, the addition polymer is “essentially free” of silicon if silicon present in the addition polymer in an amount of less than 1% by weight, based on the total weight of the addition polymer. As used herein, the addition polymer is “completely free” of silicon if silicon is not present in the addition polymer, i.e., 0% by weight.

According to the present disclosure, the addition polymer may be formed by a two-stage polymerization process. The first stage of the two-stage polymerization process comprises the formation of the polymeric dispersant from the first stage ethylenically unsaturated monomer composition as described above. The second stage of the two-stage polymerization process comprises the formation of an addition polymer comprising a polymerization product of the polymeric dispersant formed during the first stage and a second stage ethylenically unsaturated monomer composition as described above. The second stage of the polymerization process may comprise (a) dispersing the second stage ethylenically unsaturated monomer composition and a free radical initiator in a dispersing medium comprising water in the presence of the at least partially neutralized polymeric dispersant to form an aqueous dispersion, and (b) subjecting the aqueous dispersion to emulsion polymerization conditions, for example, by heating in the presence of the free radical initiator, to polymerize the components to form an aqueous dispersion comprising the formed addition polymer. The time and temperature of polymerization may depend on one another, the ingredients selected and, in some cases, the scale of the reaction. For example, the polymerization may be conducted at 40° C. to 100° C. for 2 to 20 hours.

The free radical initiator utilized for the polymerization of the polymeric dispersant and the second stage ethylenically unsaturated monomer composition may be selected from any of those used for aqueous addition polymerization techniques, including redox pair initiators, peroxides, hydroperoxides, peroxydicarbonates, azo compounds and the like. The free radical initiator may be present in an amount of 0.01% to 5% by weight, such as 0.05% to 2.0% by weight, such as 0.1% to 1.5% by weight, based on the weight of the second stage ethylenically unsaturated monomer composition. A chain transfer agent that is soluble in the monomer composition, such as alkyl mercaptans, for example, tertiary-dodecyl mercaptan, 2-mercaptoethanol, isooctyl mercaptopropionate, n-octyl mercaptan or 3-mercapto acetic acid may be used in the polymerization of the polymeric dispersant and the second stage ethylenically unsaturated monomer composition. Other chain transfer agents such as ketones, for example, methyl ethyl ketone, and chlorocarbons such as chloroform may be used. The amount of chain transfer agent, if present, may be 0.1% to 6.0% by weight, based on the weight of second stage ethylenically unsaturated monomer composition. Relatively high molecular weight multifunctional mercaptans may be substituted, all or partially, for the chain transfer agent. These molecules may, for example, range in molecular weight from about 94 to 1,000 g/mol or more. Functionality may be from about 2 to about 4. Amounts of these multifunctional mercaptans, if present, may be 0.1% to 6.0% by weight, based on the weight of the second stage ethylenically unsaturated monomer composition.

According to the present disclosure, water may be present in the aqueous dispersion in amounts of at least 40% by weight, such as at least 50% by weight, such as at least 60% by weight, such as at least 75% by weight, based on total weight of the aqueous dispersion. Water may be present in the aqueous dispersion in amounts of no more than 90% by weight, such as no more than 75% by weight, such as no more than 60% by weight, based on total weight of the aqueous dispersion. Water may be present in the aqueous dispersion in amounts of 40% to 90% by weight, such as 40% to 75% by weight, such as 40% to 60% by weight, such as 50% to 90% by weight, such as 50% to 75% by weight, such as 50% to 60% by weight, such as 60% to 90% by weight, such as 60% to 75% by weight, such as 75% to 90% by weight, based on total weight of the aqueous dispersion. The addition polymer may be added to the other components of the electrodepositable coating composition as an aqueous dispersion of the addition polymer.

In addition to water, the dispersing medium may further comprise organic cosolvents. The organic cosolvents may be at least partially soluble with water. Examples of such solvents include oxygenated organic solvents, such as monoalkyl ethers of ethylene glycol, diethylene glycol, propylene glycol, and dipropylene glycol which contain from 1 to 10 carbon atoms in the alkyl group, such as the monoethyl and monobutyl ethers of these glycols. Examples of other at least partially water-miscible solvents include alcohols such as ethanol, isopropanol, butanol and diacetone alcohol. If used, the organic cosolvents may be present in an amount of less than 10% by weight, such as less than 5% by weight, based on total weight of the dispersing medium.

According to the present disclosure, the addition polymer described above may be present in the electrodepositable coating composition in an amount of at least 0.01% by weight, such as at least 0.1% by weight, such as at least 0.3% by weight, such as at least 0.5% by weight, such as at least 0.75% by weight, such as 1% by weight, based on the total weight of the resin solids of the electrodepositable coating composition. The addition polymer described above may be present in the electrodepositable coating composition in an amount no more than 5% by weight, such as no more than 3% by weight, such as no more than 2% by weight, such as no more than 1.5% by weight, such as no more than 1% by weight, such as n no more than 0.75% by weight, based on the total weight of the resin solids of the electrodepositable coating composition. The addition polymer may be present in the electrodepositable coating composition in an amount of 0.01% to 5% by weight, such as 0.01% to 3% by weight, such as 0.01% to 2% by weight, such as 0.01% to 1.5% by weight, such as 0.01% to 1% by weight, such as 0.01% to 0.75% by weight, such as 0.1% to 5% by weight, such as 0.1% to 3% by weight, such as 0.1% to 2% by weight, such as 0.1% to 1.5% by weight, such as 0.1% to 1% by weight, such as 0.1% to 0.75% by weight, such as 0.3% to 5% by weight, such as 0.3% to 3% by weight, such as 0.3% to 2% by weight, such as 0.3% to 1.5% by weight, such as 0.3% to 1% by weight, such as 0.3% to 0.75% by weight, such as 0.5% to 5% by weight, such as 0.5% to 3% by weight, such as 0.5% to 2% by weight, such as 0.5% to 1.5% by weight, such as 0.5% to 1% by weight, such as 0.5% to 0.75% by weight, such as 1% to 5% by weight, such as 1% to 3% by weight, such as 1% to 2% by weight, such as 1% to 1.5% by weight, based on the total weight of the resin solids of the electrodepositable coating composition.

It has been surprisingly discovered that the use of the addition polymer in an electrodepositable coating composition in the amounts taught herein results in a cured coating having improved edge coverage and crater resistance as well as improved appearance.

The coated substrate may have a current flow as measured by the Enamel Rating Procedure at least 10% less when the addition polymer is present in the electrodepositable coating composition compared to a substrate coated with a comparative electrodepositable coating composition having the same composition as the electrodepositable coating composition with the exception that it does not comprise the addition polymer, such as at least 20% less, such as at least 30% less, such as at least 40% less, such as at least 50% less, such as at least 55% less, such as at least 60% less, such as at least 65% less. The Enamel Rating Procedure is fully defined in the Examples. The current flow is an indication of the amount of edge coverage provided by the electrodeposited coating. The lower the current flow, the better the edge coverage, i.e., more coating is present on the edge as indicated by more resistance to the flow of current. The use of the addition polymer of the present disclosure in the amounts described herein provides better edge coverage over comparative coating compositions that do not use the addition polymer.

The use of the addition polymer of the present disclosure in a coating composition in the amounts disclosed herein may result in a cured coating having a current flow of less than 350 mA, such as less than 300 mA, such as less than 275 mA, such as less than 250 mA, such as less than 200 mA, such as less than 150 mA, such as less than 125 mA, such as less than 100 mA, as measured by the Enamel Rating Procedure.

The presence of the addition polymer in the amounts disclosed herein in an electrodepositable coating composition may result in a reduction in the depth of craters formed in the cured coating during the curing of the electrodepositable coating composition compared to an electrodepositable coating composition that does not include the addition polymer. For example, the crater depth of the coating on the substrate may be reduced by at least 10% compared to a comparative electrodepositable coating composition having the same composition as the electrodepositable coating composition with the exception that it does not comprise the addition polymer, such as at least 20%, such as at least 30%, such as at least 40%, such as at least 50%, such as at least 55%, such as at least 60%, as measured by the Crater Resistance Test Method. The crater depth of the coating on the substrate may be 11 microns or less, such as 10 microns, or less, such as 9 microns or less, such as 8 microns or less, such as 7 microns or less, such as 6 microns or less, such as 5 microns or less, as measured by the Crater Resistance Test Method. The Crater Resistance Test Method is defined in the Examples section below.

### Ionic Salt Group-Containing Film-Forming Polymer

According to the present disclosure, the electrodepositable coating composition may further comprise an ionic salt group-containing film-forming polymer. The ionic salt group-containing film-forming polymer may be different from the addition polymer described above.

According to the present disclosure, the ionic salt group-containing film-forming polymer may comprise a cationic salt group containing film-forming polymer. The cationic salt group-containing film-forming polymer may be used in a cationic electrodepositable coating composition. As used herein, the term “cationic salt group-containing film-forming polymer” refers to polymers that include at least partially neutralized cationic groups, such as sulfonium groups and ammonium groups, that impart a positive charge. As used herein, the term “polymer” encompasses, but is not limited to, oligomers and both homopolymers and copolymers. The cationic salt group-containing film-forming polymer may comprise active hydrogen functional groups. As used herein, the term “active hydrogen functional groups” refers to those groups that are reactive with isocyanates as determined by the Zerewitinoff test as discussed above, and include, for example, hydroxyl groups, primary or secondary amine groups, and thiol groups. Cationic salt group-containing film-forming polymers that comprise active hydrogen functional groups may be referred to as active hydrogen-containing, cationic salt group-containing film-forming polymers.

Examples of polymers that are suitable for use as the cationic salt group-containing film-forming polymer in the present disclosure include, but are not limited to, alkyd polymers, acrylics, polyepoxides, polyamides, polyurethanes, polyureas, polyethers, and polyesters, among others.

More specific examples of suitable active hydrogen-containing, cationic salt group containing film-forming polymers include polyepoxide-amine adducts, such as the adduct of a polyglycidyl ethers of a polyphenol, such as Bisphenol A, and primary and/or secondary amines, such as are described in U.S. Pat. No. 4,031,050 at col. 3, line 27 to col. 5, line 50, U.S. Pat. No. 4,452,963 at col. 5, line 58 to col. 6, line 66, and U.S. Pat. No. 6,017,432 at col. 2, line 66 to col. 6, line 26, these portions of which being incorporated herein by reference. A portion of the amine that is reacted with the polyepoxide may be a ketimine of a polyamine, as is described in U.S. Pat. No. 4,104,147 at col. 6, line 23 to col. 7, line 23, the cited portion of which being incorporated herein by reference. Also suitable are ungelled polyepoxide-polyoxyalkylenepolyamine resins, such as are described in U.S. Pat. No. 4,432,850 at col. 2, line 60 to col. 5, line 58, the cited portion of which being incorporated herein by reference. In addition, cationic acrylic resins, such as those described in U.S. Pat. No. 3,455,806 at col. 2, line 18 to col. 3, line 61 and 3,928,157 at col. 2, line 29 to col. 3, line 21, these portions of both of which are incorporated herein by reference, may be used.

Besides amine salt group-containing resins, quaternary ammonium salt group-containing resins may also be employed as a cationic salt group-containing film-forming polymer in the present disclosure. Examples of these resins are those which are formed from reacting an organic polyepoxide with a tertiary amine acid salt. Such resins are described in U.S. Pat. No. 3,962,165 at col. 2, line 3 to col. 11, line 7; U.S. Pat. No. 3,975,346 at col. 1, line 62 to col. 17, line 25 and U.S. Pat. No. 4,001,156 at col. 1, line 37 to col. 16, line 7, these portions of which being incorporated herein by reference. Examples of other suitable cationic resins include ternary sulfonium salt group-containing resins, such as those described in U.S. Pat. No. 3,793,278 at col. 1, line 32 to col. 5, line 20, this portion of which being incorporated herein by reference. Also, cationic resins which cure via a transesterification mechanism, such as described in European Pat. Application No. 12463B1 at pg. 2, line 1 to pg. 6, line 25, this portion of which being incorporated herein by reference, may also be employed.

Other suitable cationic salt group-containing film-forming polymers include those that may form photodegradation resistant electrodepositable coating compositions. Such polymers include the polymers comprising cationic amine salt groups which are derived from pendant and/or terminal amino groups that are disclosed in U.S. Pat. Application Publication No. 2003/0054193 A1 at paragraphs [0064] to [0088], this portion of which being incorporated herein by reference. Also suitable are the active hydrogen-containing, cationic salt group-containing resins derived from a polyglycidyl ether of a polyhydric phenol that is essentially free of aliphatic carbon atoms to which are bonded more than one aromatic group, which are described in U.S. Pat. Application Publication No. 2003/0054193 A1 at paragraphs

to [0123], this portion of which being incorporated herein by reference.

The active hydrogen-containing, cationic salt group-containing film-forming polymer is made cationic and water dispersible by at least partial neutralization with an acid. Suitable acids include organic and inorganic acids. Non-limiting examples of suitable organic acids include formic acid, acetic acid, methanesulfonic acid, and lactic acid. Non-limiting examples of suitable inorganic acids include phosphoric acid and sulfamic acid. By “sulfamic acid” is meant sulfamic acid itself or derivatives thereof such as those having the formula:

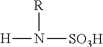

wherein R is hydrogen or an alkyl group having 1 to 4 carbon atoms. Mixtures of the above-mentioned acids also may be used in the present disclosure.

The extent of neutralization of the cationic salt group-containing film-forming polymer may vary with the particular polymer involved. However, sufficient acid should be used to sufficiently neutralize the cationic salt-group containing film-forming polymer such that the cationic salt-group containing film-forming polymer may be dispersed in an aqueous dispersing medium. For example, the amount of acid used may provide at least 20% of all of the total theoretical neutralization. Excess acid may also be used beyond the amount required for 100% total theoretical neutralization. For example, the amount of acid used to neutralize the cationic salt group-containing film-forming polymer may be ≥0.1% based on the total amines in the active hydrogen-containing, cationic salt group-containing film-forming polymer. Alternatively, the amount of acid used to neutralize the active hydrogen-containing, cationic salt group-containing film-forming polymer may be ≤100% based on the total amines in the active hydrogen-containing, cationic salt group-containing film-forming polymer. The total amount of acid used to neutralize the cationic salt group-containing film-forming polymer may range between any combination of values, which were recited in the preceding sentences, inclusive of the recited values. For example, the total amount of acid used to neutralize the active hydrogen-containing, cationic salt group-containing film-forming polymer may be 20%, 35%, 50%, 60%, or 80% based on the total amines in the cationic salt group-containing film-forming polymer.

According to the present disclosure, the cationic salt group-containing film-forming polymer may be present in the cationic electrodepositable coating composition in an amount of at least 40% by weight, such as at least 50% by weight, such as at least 60% by weight, based on the total weight of the resin solids of the electrodepositable coating composition. The cationic salt group-containing film-forming polymer may be present in the cationic electrodepositable coating composition in an amount of no more than 90% by weight, such as no more than 80% by weight, such as no more than 75% by weight, based on the total weight of the resin solids of the electrodepositable coating composition. The cationic salt group-containing film-forming polymer may be present in the cationic electrodepositable coating composition in an amount of 40% to 90% by weight, such as 40% to 80% by weight, such as 40% to 75% by weight, such as 50% to 90% by weight, such as 50% to 80% by weight, such as 50% to 75% by weight, such as 60% to 90% by weight, such as 60% to 80% by weight, such as 60% to 75% by weight, based on the total weight of the resin solids of the electrodepositable coating composition.

As used herein, the “resin solids” include the ionic salt group-containing film-forming polymer, the curing agent, the addition polymer, and any additional water-dispersible non-pigmented component(s) present in the electrodepositable coating composition.

According to the present disclosure, the ionic salt group containing film-forming polymer may comprise an anionic salt group containing film-forming polymer. As used herein, the term “anionic salt group containing film-forming polymer” refers to an anionic polymer comprising at least partially neutralized anionic functional groups, such as carboxylic acid and phosphoric acid groups that impart a negative charge. As used herein, the term “polymer” encompasses, but is not limited to, oligomers and both homopolymers and copolymers. The anionic salt group-containing film-forming polymer may comprise active hydrogen functional groups. As used herein, the term “active hydrogen functional groups” refers to those groups that are reactive with isocyanates as determined by the Zerewitinoff test as discussed above, and include, for example, hydroxyl groups, primary or secondary amine groups, and thiol groups. Anionic salt group-containing film-forming polymers that comprise active hydrogen functional groups may be referred to as active hydrogen-containing, anionic salt group-containing film-forming polymers. The anionic salt group containing film-forming polymer may be used in an anionic electrodepositable coating composition.

The anionic salt group-containing film-forming polymer may comprise base-solubilized, carboxylic acid group-containing film-forming polymers such as the reaction product or adduct of a drying oil or semi-drying fatty acid ester with a dicarboxylic acid or anhydride; and the reaction product of a fatty acid ester, unsaturated acid or anhydride and any additional unsaturated modifying materials which are further reacted with polyol. Also suitable are the at least partially neutralized interpolymers of hydroxy-alkyl esters of unsaturated carboxylic acids, unsaturated carboxylic acid and at least one other ethylenically unsaturated monomer. Still another suitable anionic electrodepositable resin comprises an alkyd-aminoplast vehicle, i.e., a vehicle containing an alkyd resin and an amine-aldehyde resin. Another suitable anionic electrodepositable resin composition comprises mixed esters of a resinous polyol. Other acid functional polymers may also be used such as phosphatized polyepoxide or phosphatized acrylic polymers. Exemplary phosphatized polyepoxides are disclosed in U.S. Pat. Application Publication No. 2009-0045071 at [0004]-[0015] and U.S. patent application Ser. No. 13/232,093 at [0014]-[0040], the cited portions of which being incorporated herein by reference. Also suitable are resins comprising one or more pendent carbamate functional groups, such as those described in U.S. Pat. No. 6,165,338.

According to the present disclosure, the anionic salt group-containing film-forming polymer may be present in the anionic electrodepositable coating composition in an amount of at least 50% by weight, such as at least 55% by weight, such as at least 60% by weight, based on the total weight of the resin solids of the electrodepositable coating composition. The anionic salt group-containing film-forming polymer may be present in the anionic electrodepositable coating composition in an amount of no more than 90% by weight, such as no more than 80% by weight, such as no more than 75% by weight, based on the total weight of the resin solids of the electrodepositable coating composition. The anionic salt group-containing film-forming polymer may be present in the anionic electrodepositable coating composition in an amount 50% to 90%, such as 50% to 80% by weight, such as 50% to 75% by weight, such as 55% to 90% by weight, such as 55% to 80%, such as 55% to 75% by weight, such as 60% to 90% by weight, such as 60% to 80% by weight, such as 60% to 75%, based on the total weight of the resin solids of the electrodepositable coating composition.

According to the present disclosure, the ionic salt group-containing film-forming polymer may be present in the electrodepositable coating composition in an amount of at least 40% by weight, such as at least 50% by weight, such as at least 55% by weight, such as at least 60% by weight, based on the total weight of the resin solids of the electrodepositable coating composition. The ionic salt group-containing film-forming polymer may be present in the electrodepositable coating composition in an amount of no more than 90% by weight, such as no more than 80% by weight, such as no more than 75% by weight, based on the total weight of the resin solids of the electrodepositable coating composition. The ionic salt group-containing film-forming polymer may be present in the electrodepositable coating composition in an amount of 40% to 90% by weight, such as 40% to 80% by weight, such as 40% to 75% by weight, such as 50% to 90% by weight, such as 50% to 80% by weight, such as 50% to 75% by weight, such as 55% to 90% by weight, such as 55% to 80% by weight, such as 55% to 75% by weight, such as 60% to 90% by weight, such as 60% to 80% by weight, such as 60% to 75% by weight, based on the total weight of the resin solids of the electrodepositable coating composition.

### Curing Agent

According to the present disclosure, the electrodepositable coating composition of the present disclosure may further comprise a curing agent. The curing agent may be reactive with the addition polymer and the ionic salt group-containing film-forming polymer. The curing agent may react with the reactive groups, such as active hydrogen groups, of the ionic salt group-containing film-forming polymer and the addition polymer to effectuate cure of the coating composition to form a coating. As used herein, the term “cure”, “cured” or similar terms, as used in connection with the electrodepositable coating compositions described herein, means that at least a portion of the components that form the electrodepositable coating composition are crosslinked to form a coating. Additionally, curing of the electrodepositable coating composition refers to subjecting said composition to curing conditions (e.g., elevated temperature) leading to the reaction of the reactive functional groups of the components of the electrodepositable coating composition, and resulting in the crosslinking of the components of the composition and formation of an at least partially cured coating. Non-limiting examples of suitable curing agents are at least partially blocked polyisocyanates, aminoplast resins and phenoplast resins, such as phenolformaldehyde condensates including allyl ether derivatives thereof.

Suitable at least partially blocked polyisocyanates include aliphatic polyisocyanates, aromatic polyisocyanates, and mixtures thereof. The curing agent may comprise an at least partially blocked aliphatic polyisocyanate. Suitable at least partially blocked aliphatic polyisocyanates include, for example, fully blocked aliphatic polyisocyanates, such as those described in U.S. Pat. No. 3,984,299 at col. 1 line 57 to col. 3 line 15, this portion of which is incorporated herein by reference, or partially blocked aliphatic polyisocyanates that are reacted with the polymer backbone, such as is described in U.S. Pat. No. 3,947,338 at col. 2 line 65 to col. 4 line 30, this portion of which is also incorporated herein by reference. By “blocked” is meant that the isocyanate groups have been reacted with a compound such that the resultant blocked isocyanate group is stable to active hydrogens at ambient temperature but reactive with active hydrogens in the film forming polymer at elevated temperatures, such as between 90° C. and 200° C. The polyisocyanate curing agent may be a fully blocked polyisocyanate with substantially no free isocyanate groups.

The polyisocyanate curing agent may comprise a diisocyanate, higher functional polyisocyanates or combinations thereof. For example, the polyisocyanate curing agent may comprise aliphatic and/or aromatic polyisocyanates. Aliphatic polyisocyanates may include (i) alkylene isocyanates, such as trimethylene diisocyanate, tetramethylene diisocyanate, pentamethylene diisocyanate, hexamethylene diisocyanate (“HDI”), 1,2-propylene diisocyanate, 1,2-butylene diisocyanate, 2,3-butylene diisocyanate, 1,3-butylene diisocyanate, ethylidene diisocyanate, and butylidene diisocyanate, and (ii) cycloalkylene isocyanates, such as 1,3-cyclopentane diisocyanate, 1,4-cyclohexane diisocyanate, 1,2-cyclohexane diisocyanate, isophorone diisocyanate, methylene bis(4-cyclohexylisocyanate) (“HMDI”), the cyclo-trimer of 1,6-hexmethylene diisocyanate (also known as the isocyanurate trimer of HDI, commercially available as Desmodur N3300 from Convestro AG), and meta-tetramethylxylylene diisocyanate (commercially available as TMXDI® from Allnex SA). Aromatic polyisocyanates may include (i) arylene isocyanates, such as m-phenylene diisocyanate, p-phenylene diisocyanate, 1,5-naphthalene diisocyanate and 1,4-naphthalene diisocyanate, and (ii) alkarylene isocyanates, such as 4,4′-diphenylene methane (“MDI”), 2,4-tolylene or 2,6-tolylene diisocyanate (“TDI”), or mixtures thereof, 4,4-toluidine diisocyanate and xylylene diisocyanate. Triisocyanates, such as triphenyl methane-4,4′,4″-triisocyanate, 1,3,5-triisocyanato benzene and 2,4,6-triisocyanato toluene, tetraisocyanates, such as 4,4′-diphenyldimethyl methane-2,2′,5,5′-tetraisocyanate, and polymerized polyisocyanates, such as tolylene diisocyanate dimers and trimers and the like, may also be used. The curing agent may comprise a blocked polyisocyanate selected from a polymeric polyisocyanate, such as polymeric HDI, polymeric MDI, polymeric isophorone diisocyanate, and the like. The curing agent may also comprise a blocked trimer of hexamethylene diisocyanate available as Desmodur N3300® from Covestro AG. Mixtures of polyisocyanate curing agents may also be used.

The polyisocyanate curing agent may be at least partially blocked with at least one blocking agent selected from a 1,2-alkane diol, for example 1,2-propanediol; a 1,3-alkane diol, for example 1,3-butanediol; a benzylic alcohol, for example, benzyl alcohol; an allylic alcohol, for example, allyl alcohol; caprolactam; a dialkylamine, for example dibutylamine; and mixtures thereof. The polyisocyanate curing agent may be at least partially blocked with at least one 1,2-alkane diol having three or more carbon atoms, for example 1,2-butanediol.

Other suitable blocking agents include aliphatic, cycloaliphatic, or aromatic alkyl monoalcohols or phenolic compounds, including, for example, lower aliphatic alcohols, such as methanol, ethanol, and n-butanol; cycloaliphatic alcohols, such as cyclohexanol; aromatic-alkyl alcohols, such as phenyl carbinol and methylphenyl carbinol; and phenolic compounds, such as phenol itself and substituted phenols wherein the substituents do not affect coating operations, such as cresol and nitrophenol. Glycol ethers and glycol amines may also be used as blocking agents. Suitable glycol ethers include ethylene glycol butyl ether, diethylene glycol butyl ether, ethylene glycol methyl ether and propylene glycol methyl ether. Other suitable blocking agents include oximes, such as methyl ethyl ketoxime, acetone oxime and cyclohexanone oxime.

The curing agent may comprise an aminoplast resin Aminoplast resins are condensation products of an aldehyde with an amino- or amido-group carrying substance. Condensation products obtained from the reaction of alcohols and an aldehyde with melamine, urea or benzoguanamine may be used. However, condensation products of other amines and amides may also be employed, for example, aldehyde condensates of triazines, diazines, triazoles, guanidines, guanamines and alkyl- and aryl-substituted derivatives of such compounds, including alkyl- and aryl-substituted ureas and alkyl- and aryl-substituted melamines Some examples of such compounds are N,N′-dimethyl urea, benzourea, dicyandiamide, formaguanamine, acetoguanamine, ammeline, 2-chloro-4,6-diamino-1,3,5-triazine, 6-methyl-2,4-diamino-1,3,5-triazine, 3,5-diaminotriazole, triaminopyrimidine, 2-mercapto-4,6-diaminopyrimidine, 3,4,6-tris(ethylamino)-1,3,5-triazine, and the like. Suitable aldehydes include formaldehyde, acetaldehyde, crotonaldehyde, acrolein, benzaldehyde, furfural, glyoxal and the like.

The aminoplast resins may contain methylol or similar alkylol groups, and at least a portion of these alkylol groups may be etherified by a reaction with an alcohol to provide organic solvent-soluble resins. Any monohydric alcohol may be employed for this purpose, including such alcohols as methanol, ethanol, propanol, butanol, pentanol, hexanol, heptanol and others, as well as benzyl alcohol and other aromatic alcohols, cyclic alcohol such as cyclohexanol, monoethers of glycols such as Cello solves and Carbitols, and halogen-substituted or other substituted alcohols, such as 3-chloropropanol and butoxyethanol.

Non-limiting examples of commercially available aminoplast resins are those available under the trademark CYMEL® from Allnex Belgium SA/NV, such as CYMEL 1130 and 1156, and RESIMENE® from INEOS Melamines, such as RESIMENE 750 and 753. Examples of suitable aminoplast resins also include those described in U.S. Pat. No. 3,937,679 at col. 16, line 3 to col. 17, line 47, this portion of which being hereby incorporated by reference. As is disclosed in the aforementioned portion of the '679 patent, the aminoplast may be used in combination with the methylol phenol ethers.

Phenoplast resins are formed by the condensation of an aldehyde and a phenol. Suitable aldehydes include formaldehyde and acetaldehyde. Methylene-releasing and aldehyde-releasing agents, such as paraformaldehyde and hexamethylene tetramine, may also be utilized as the aldehyde agent. Various phenols may be used, such as phenol itself, a cresol, or a substituted phenol in which a hydrocarbon radical having either a straight chain, a branched chain or a cyclic structure is substituted for a hydrogen in the aromatic ring. Mixtures of phenols may also be employed. Some specific examples of suitable phenols are p-phenylphenol, p-tert-butylphenol, p-tert-amylphenol, cyclopentylphenol and unsaturated hydrocarbon-substituted phenols, such as the monobutenyl phenols containing a butenyl group in ortho, meta or para position, and where the double bond occurs in various positions in the hydrocarbon chain.

Aminoplast and phenoplast resins, as described above, are described in U.S. Pat. No. 4,812,215 at co1.6, line 20 to col. 7, line 12, the cited portion of which being incorporated herein by reference.

The curing agent may be present in the cationic electrodepositable coating composition in an amount of at least 10% by weight, such as at least 20% by weight, such as at least 25% by weight, based on the total weight of the resin solids of the electrodepositable coating composition. The curing agent may be present in the cationic electrodepositable coating composition in an amount of no more than 60% by weight, such as no more than 50% by weight, such as no more than 40% by weight, based on the total weight of the resin solids of the electrodepositable coating composition. The curing agent may be present in the cationic electrodepositable coating composition in an amount of 10% to 60% by weight, such as 10% to 50% by weight, such as 10% to 40% by weight, such as 20% to 60% by weight, such as 20% to 50% by weight, such as 20% to 40% by weight, such as 25% to 60% by weight, such as 25% to 50% by weight, such as 25% to 40% by weight, based on the total weight of the resin solids of the electrodepositable coating composition.

The curing agent may be present in the anionic electrodepositable coating composition in an amount of at least 10% by weight, such as at least 20% by weight, such as at least 25% by weight, based on the total weight of the resin solids of the electrodepositable coating composition. The curing agent may be present in the anionic electrodepositable coating composition in an amount of no more than 50% by weight, such as no more than 45% by weight, such as no more than 40% by weight, based on the total weight of the resin solids of the electrodepositable coating composition. The curing agent may be present in the anionic electrodepositable coating composition in an amount of 10% to 50% by weight, such as 10% to 45% by weight, such as 10% to 40% by weight, such as 20% to 50% by weight, such as 20% to 45% by weight, such as 20% to 40% by weight, such as 25% to 50% by weight, such as 25% to 45% by weight, such as 25% to 40% by weight, based on the total weight of the resin solids of the electrodepositable coating composition.

The curing agent may be present in the electrodepositable coating composition in an amount of at least 10% by weight, such as at least 20% by weight, such as at least 25% by weight, based on the total weight of the resin solids of the electrodepositable coating composition. The curing agent may be present in the electrodepositable coating composition in an amount of no more than 60% by weight, such as no more than 50% by weight, such as no more than 45% by weight, such as no more than 40% by weight, based on the total weight of the resin solids of the electrodepositable coating composition. The curing agent may be present in the electrodepositable coating composition in an amount of 10% to 60% by weight, such as 10% to 50% by weight, such as 10% to 45% by weight, such as 10% to 40% by weight, such as 20% to 60% by weight, such as 20% to 50% by weight, such as 20% to 45% by weight, such as 20% to 40% by weight, such as 25% to 60% by weight, such as 25% to 50% by weight, such as 25% to 45% by weight, such as 25% to 40% by weight, based on the total weight of the resin solids of the electrodepositable coating composition.

### Further Components of the Electrodepositable Coating Compositions

The electrodepositable coating composition according to the present disclosure may optionally comprise one or more further components in addition to the addition polymer, the ionic salt group-containing film-forming polymer and the curing agent described above.

According to the present disclosure, the electrodepositable coating composition may optionally comprise a catalyst to catalyze the reaction between the curing agent and the polymers. Examples of catalysts suitable for cationic electrodepositable coating compositions include, without limitation, organotin compounds (e.g., dibutyltin oxide and dioctyltin oxide) and salts thereof (e.g., dibutyltin diacetate); other metal oxides (e.g., oxides of cerium, zirconium and bismuth) and salts thereof (e.g., bismuth sulfamate and bismuth lactate); or a cyclic guanidine as described in U.S. Pat. No. 7,842,762 at col. 1, line 53 to col. 4, line 18 and col. 16, line 62 to col. 19, line 8, the cited portions of which being incorporated herein by reference. Examples of catalysts suitable for anionic electrodepositable coating compositions include latent acid catalysts, specific examples of

which are identified in WO 2007/118024 at and include, but are not limited to, ammonium hexafluoroantimonate, quaternary salts of SbF 6 (e.g., NACURE® XC-7231), t-amine salts of SbF₆ (e.g., NACURE® XC-9223), Zn salts of triflic acid (e.g., NACURE® A202 and A218), quaternary salts of triflic acid (e.g., NACURE® XC-A230), and diethylamine salts of triflic acid (e.g., NACURE® A233), all commercially available from King Industries, and/or mixtures thereof. Latent acid catalysts may be formed by preparing a derivative of an acid catalyst such as para-toluenesulfonic acid (pTSA) or other sulfonic acids. For example, a well-known group of blocked acid catalysts are amine salts of aromatic sulfonic acids, such as pyridinium para-toluenesulfonate. Such sulfonate salts are less active than the free acid in promoting crosslinking. During cure, the catalysts may be activated by heating.

According to the present disclosure, the electrodepositable coating compositions of the present disclosure may optionally comprise crater control additives which may be incorporated into the coating composition, such as, for example, a polyalkylene oxide polymer which may comprise a copolymer of butylene oxide and propylene oxide. According to the present disclosure, the molar ratio of butylene oxide to propylene oxide may be at least 1:1, such as at least 3:1, such as at least 5:1, and in some instances, may be no more than 50:1, such as no more than 30:1, such as no more than 20:1. According to the present disclosure, the molar ratio of butylene oxide to propylene oxide may be 1:1 to 50:1, such as 3:1 to 30:1, such as 5:1 to 20:1.

The polyalkylene oxide polymer may comprise at least two hydroxyl functional groups, and may be monofunctional, difunctional, trifunctional, or tetrafunctional. As used herein, a “hydroxyl functional group” comprises an —OH group. For clarity, the polyalkylene oxide polymer may comprise additional functional groups in addition to the hydroxyl functional group(s). As used herein, “monofunctional,” when used with respect to the number of hydroxyl functional groups a particular monomer or polymer comprises, means a monomer or polymer comprising one (1) hydroxyl functional group per molecule. As used herein, “difunctional,” when used with respect to the number of hydroxyl functional groups a particular monomer or polymer comprises, means a monomer or polymer comprising two (2) hydroxyl functional groups per molecule. As used herein, “trifunctional,” when used with respect to the number of hydroxyl functional groups a particular monomer or polymer comprises, means a monomer or polymer comprising three (3) hydroxyl functional groups per molecule. As used herein, “tetrafunctional,” when used with respect to the number of hydroxyl functional groups a particular monomer or polymer comprises, means a monomer or polymer comprising four (4) hydroxyl functional groups per molecule.

The hydroxyl equivalent weight of the polyalkylene oxide polymer may be at least 100 g/mol, such as at least 200 g/mol, such as at least 400 g/mol, and may be no more than 2,000 g/mol, such as no more than 1,000 g/mol, such as no more than 800 g/mol. The hydroxyl equivalent weight of the polyalkylene oxide polymer may be 100 g/mol to 2,000 g/mol, such as 200 g/mol to 1,000 g/mol, such as 400 g/mol to 800 g/mol. As used herein, with respect to the polyalkylene oxide polymer, the “hydroxyl equivalent weight” is determined by dividing the molecular weight of the polyalkylene oxide polymer by the number of hydroxyl groups present in the polyalkylene oxide polymer.

The polyalkylene oxide polymer may have a z-average molecular weight (M_{z}) of at least 200 g/mol, such as at least 400 g/mol, such as at least 600 g/mol, and may be no more than 5,000 g/mol, such as no more than 3,000 g/mol, such as no more than 2,000 g/mol. According to the present disclosure, the polyalkylene oxide polymer may have a z-average molecular weight of 200 g/mol to 5,000 g/mol, such as 400 g/mol to 3,000 g/mol, such as 600 g/mol to 2,000 g/mol. As used herein, with respect to polyalkylene oxide polymers having a z-average molecular weight (M_{z}) of less than 900,000, the term “z-average molecular weight (M_{z})” means the z-average molecular weight (M t) as determined by Gel Permeation Chromatography using Waters 2695 separation module with a Waters 410 differential refractometer (RI detector), polystyrene standards having molecular weights of from approximately 500 g/mol to 900,000 g/mol, tetrahydrofuran (THF) with 0.05 M lithium bromide (LiBr) as the eluent at a flow rate of 0.5 mL/min, and one Asahipak GF-510 HQ column for separation.

The polyalkylene oxide polymer may be present in the electrodepositable coating composition in an amount of at least 0.1% by weight based on the total weight of the resin blend solids, such as at least 0.5% by weight, such as at least 0.75% by weight, and in some instances, may be present in the electrodepositable coating composition in an amount of no more than 10% by weight based on the total weight of the resin blend solids, such as no more than 4% by weight, such as no more than 3% by weight. The polyalkylene oxide polymer may be present in the electrodepositable coating composition in an amount of at 0.1% by weight to 10% by weight based on the total weight of the resin blend solids, such as 0.5% by weight to 4% by weight, such as 0.75% by weight to 3% by weight.

According to the present disclosure, the electrodepositable coating composition may comprise other optional ingredients, such as various additives such as fillers, plasticizers, antioxidants, biocides, UV light absorbers and stabilizers, hindered amine light stabilizers, defoamers, fungicides, dispersing aids, flow control agents, surfactants, wetting agents, or combinations thereof. Alternatively, the electrodepositable coating composition may be completely free of any of the optional ingredients, i.e., the optional ingredient is not present in the electrodepositable coating composition. The other additives mentioned above may be present in the electrodepositable coating composition in amounts of 0.01% to 3% by weight, based on total weight of the resin solids of the electrodepositable coating composition.

The electrodepositable coating composition may optionally further comprise a pigment. The pigment may comprise suitable pigment. Non-limiting examples of a suitable pigment include an iron oxide, a lead oxide, strontium chromate, carbon black, coal dust, titanium dioxide, barium sulfate, a color pigment, a phyllosilicate pigment, a metal pigment, a thermally conductive, electrically insulative filler, fire-retardant pigment, or any combination thereof, among others.

According to the present disclosure, the cationic electrodepositable coating composition of the present disclosure may further comprise a pigment and a dispersing acid.

The pigment may comprise a phyllosilicate pigment. As used herein, the term “phyllosilicate” refers to a group of minerals having sheets of silicates having a basic structure based on interconnected six membered rings of SiO₄⁻⁴ tetrahedra that extend outward in infinite sheets where 3 out of the 4 oxygens from each tetrahedra are shared with other tetrahedra resulting in phyllosilicates having the basic structural unit of Si₂O₅⁻². Phyllosilicates may comprise hydroxide ions located at the center of the tetrahedra and/or cations such as, for example, Fe⁺², Mg⁺², or Al⁺³, that form cation layers between the silicate sheets where the cations may coordinate with the oxygen of the silicate layer and/or the hydroxide ions. The term “phyllosilicate pigment” refers to pigment materials comprising phyllosilicates. Non-limiting examples of phyllosilicate pigments includes the micas, chlorites, serpentine, talc, and the clay minerals. The clay minerals include, for example, kaolin clay and smectite clay. The sheet-like structure of the phyllosilicate pigment tends to result in pigment having a plate-like structure, although the pigment can be manipulated (such as through mechanical means) to have other particle structures. These pigments when exposed to liquid media may or may not swell and may or may not have leachable components (e.g.: ions that may be drawn towards, and carried away in, the liquid media).

The phyllosilicate pigment may comprise a plate-like pigment. For example, the phyllosilicate pigment may comprise a plate-like mica pigment, a plate-like chlorite pigment, a plate-like serpentine pigment, a plate-like talc pigment, and/or a plate-like clay pigment. The plate-like clay pigment may comprise kaolin clay, smectite clay, or a combination thereof.

As used herein, the term “dispersing acid” refers to a material capable of forming a chemical complex with the phyllosilicate pigment and may assist in promoting dispersion of the phyllosilicate pigment.

The phyllosilicate pigment and dispersing acid may optionally form a complex, and the phyllosilicate pigment-dispersing acid complex of the present disclosure may optionally have an overall anionic charge. As used herein, the term “complex” refers to a substance formed by the chemical interaction, such as ionic bonding, covalent bonding, and/or hydrogen bonding, between two distinct chemical species. As used herein, the term “overall anionic charge” with respect to the complex means that the complex is at least partially negatively charged and may have some portions positively charged, but the negative charges are greater than the positive charges such that the complex has an anionic charged. These species will generally be part of a dispersion phase having one component or multiple components that is not soluble in the bulk media and other component(s) that are soluble in the bulk material.

The dispersing acid may be a monoprotic acid or polyprotic acid. As used herein, the term “polyprotic acid” refers to chemical compounds having more than one acidic proton. As used herein, the term “acidic proton” refers to a proton that forms part of an acid group, including, but not limited to, oxyacids of phosphorus, carboxylic acids, oxyacids of sulfur, and the like.

The dispersing acid may comprise a first acidic proton having a pKa of at least 1.1, such as at least 1.5, such as at least 1.8. The dispersing acid may comprise a first acidic proton having a pKa of no more than 4.6, such as no more than 4.0, such as no more than 3.5. The dispersing acid may comprise a first acidic proton having a pKa of 1.1 to 4.6, such as 1.5 to 4.0, such as 1.8 to 3.5.

The dispersing acid may comprise a carboxylic acid, an oxyacid of phosphorus (such as phosphoric acid or phosphonic acid), or a combination thereof.

The dispersing acid may form a complex with the phyllosilicate pigment, and the phyllosilicate pigment-dispersing acid complex may comprise a phyllosilicate pigment-dispersing acid complex. The dispersing acid may deprotonate in the aqueous medium of the composition to form a negative (or more negative) charge, and the deprotonated acid dispersant may form a complex with the positively charged edges of the plate-like phyllosilicate pigment. The complex optionally may have an overall more negative charge than the phyllosilicate pigment does itself, i.e., the phyllosilicate pigment-dispersing acid complex may have an overall anionic charge.

The ratio of the weight of phyllosilicate pigment to moles of dispersing acid may be at least 0.25 g/mmol, such as at least 0.5 g/mmol, such as at least 1.0 g/mmol, such as at least 1.5 g/mmol, such as at least 1.75 g/mmol. The ratio of the weight of phyllosilicate pigment to moles of dispersing acid may be no more than 196 g/mmol, such as no more than 100 g/mmol, such as no more than 50 g/mmol, such as no more than 25 g/mmol, such as no more than 15 g/mmol, such as no more than 10 g/mmol, such as no more than 8.25 g/mmol, such as no more than 6.5 g/mmol, such as no more than 5.0 g/mmol. The ratio of the weight of phyllosilicate pigment to moles of dispersing acid may be in the amount of 0.25 to 196 g/mmol, such as 0.25 to 100 g/mmol, such as 0.25 to 50 g/mmol, such as 0.25 to 25 g/mmol, such as 0.25 to 15 g/mmol, such as 0.25 to 10 g/mmol, such as 0.25 to 8.25 g/mmol, such as 0.25 to 6.5 g/mmol, such as 0.25 to 5.0 g/mmol, such as 0.5 to 196 g/mmol, such as 0.5 to 100 g/mmol, such as 0.5 to 50 g/mmol, such as 0.5 to 25 g/mmol, such as 0.5 to 15 g/mmol, such as 0.5 to 10 g/mmol, such as 0.5 to 8.25 g/mmol, such as 0.5 to 6.5 g/mmol, such as 0.5 to 5.0 g/mmol, such as 1.0 to 196 g/mmol, such as 1.0 to 100 g/mmol, such as 1.0 to 50 g/mmol, such as 1.0 to 25 g/mmol, such as 1.0 to 15 g/mmol, such as 1.0 to 10 g/mmol, such as 1.0 to 8.25 g/mmol, such as 1.0 to 6.5 g/mmol, such as 1.0 to 5.0 g/mmol, such as 1.5 to 196 g/mmol, such as 1.5 to 100 g/mmol, such as 1.5 to 50 g/mmol, such as 1.5 to 25 g/mmol, such as 1.5 to 15 g/mmol, such as 1.5 to 10 g/mmol, such as 1.5 to 8.25 g/mmol, such as 1.5 to 6.5 g/mmol, such as 1.5 to 5.0 g/mmol, such as 1.75 to 196 g/mmol, such as 1.75 to 100 g/mmol, such as 1.75 to 50 g/mmol, such as 1.75 to 25 g/mmol, such as 1.75 to 15 g/mmol, such as 1.75 to 10 g/mmol, such as 1.75 to 8.25 g/mmol, such as 1.75 to 6.5 g/mmol, such as 1.75 to 5.0 g/mmol.

The pigment-to-binder (P:B) ratio as set forth in this disclosure may refer to the weight ratio of the pigment-to-binder in the electrodepositable coating composition, and/or the weight ratio of the pigment-to-binder in the deposited wet film, and/or the weight ratio of the pigment to the binder in the dry, uncured deposited film, and/or the weight ratio of the pigment-to-binder in the cured film. The pigment-to-binder (P:B) ratio of the pigment to the electrodepositable binder may be at least 0.05:1, such as at least 0.1:1, such as at least 0.2:1, such as at least 0.30:1, such as at least 0.35:1, such as at least 0.40:1, such as at least 0.50:1, such as at least 0.60:1, such as at least 0.75:1, such as at least 1:1, such as at least 1.25:1, such as at least 1.5:1. The pigment-to-binder (P:B) ratio of the pigment to the electrodepositable binder may be no more than 2.0:1, such as no more than 1.75:1, such no more than 1.5:1, such as no more than 1.25:1, such as no more than 1:1, such as no more than 0.75:1, such as no more than 0.70:1, such as no more than 0.60:1, such as no more than 0.55:1, such as no more than 0.50:1, such as no more than 0.30:1, such as no more than 0.20:1, such as no more than 0.10:1. The pigment-to-binder (P:B) ratio of the pigment to the electrodepositable binder may be 0.05:1 to 2.0:1, such as 0.05:1 to 1.75:1, such as 0.05:1 to 1.50:1, such as 0.05:1 to 1.25:1, such as 0.05:1 to 1:1, such as 0.05:1 to 0.75:1, such as 0.05:1 to 0.70:1, such as 0.05:1 to 0.60:1, such as 0.05:1 to 0.55:1, such as 0.05:1 to 0.50:1, such as 0.05:1 to 0.30:1, such as 0.05:1 to 0.20:1, such as 0.05:1 to 0.10:1, such as 0.1:1 to 2.0:1, such as 0.1:1 to 1.75:1, such as 0.1:1 to 1.50:1, such as 0.1:1 to 1.25:1, such as 0.1:1 to 1:1, such as 0.1:1 to 0.75:1, such as 0.1:1 to 0.70:1, such as 0.1:1 to 0.60:1, such as 0.1:1 to 0.55:1, such as 0.1:1 to 0.50:1, such as 0.1:1 to 0.30:1, such as 0.1:1 to 0.20:1, such as 0.2:1 to 2.0:1, such as 0.2:1 to 1.75:1, such as 0.2:1 to 1.50:1, such as 0.2:1 to 1.25:1, such as 0.2:1 to 1:1, such as 0.2:1 to 0.75:1, such as 0.2:1 to 0.70:1, such as 0.2:1 to 0.60:1, such as 0.2:1 to 0.55:1, such as 0.2:1 to 0.50:1, such as 0.2:1 to 0.30:1, such as 0.3:1 to 2.0:1, such as 0.3:1 to 1.75:1, such as 0.3:1 to 1.50:1, such as 0.3:1 to 1.25:1, such as 0.3:1 to 1:1, such as 0.3:1 to 0.75:1, such as 0.3:1 to 0.70:1, such as 0.3:1 to 0.60:1, such as 0.3:1 to 0.55:1, such as 0.3:1 to 0.50:1, such as 0.3:1 to 0.30:1, such as 0.35:1 to 2.0:1, such as 0.35:1 to 1.75:1, such as 0.35:1 to 1.50:1, such as 0.35:1 to 1.25:1, such as 0.35:1 to 1:1, such as 0.35:1 to 0.75:1, such as 0.35:1 to 0.70:1, such as 0.35:1 to 0.60:1, such as 0.35:1 to 0.55:1, such as 0.35:1 to 0.50:1, such as 0.4:1 to 2.0:1, such as 0.4:1 to 1.75:1, such as 0.4:1 to 1.50:1, such as 0.4:1 to 1.25:1, such as 0.4:1 to 1:1, such as 0.4:1 to 0.75:1, such as 0.4:1 to 0.70:1, such as 0.4:1 to 0.60:1, such as 0.4:1 to 0.55:1, such as 0.4:1 to 0.50:1, such as 0.5:1 to 2.0:1, such as 0.5:1 to 1.75:1, such as 0.5:1 to 1.50:1, such as 0.5:1 to 1.25:1, such as 0.5:1 to 1:1, such as 0.5:1 to 0.75:1, such as 0.5:1 to 0.70:1, such as 0.5:1 to 0.60:1, such as 0.5:1 to 0.55:1, such as 0.6:1 to 2.0:1, such as 0.6:1 to 1.75:1, such as 0.6:1 to 1.50:1, such as 0.6:1 to 1.25:1, such as 0.6:1 to 1:1, such as 0.6:1 to 0.75:1, such as 0.6:1 to 0.70:1, such as 0.75:1 to 2.0:1, such as 0.75:1 to 1.75:1, such as 0.75:1 to 1.50:1, such as 0.75:1 to 1.25:1, such as 0.75:1 to 1:1, such as 1:1 to 2.0:1, such as 1:1 to 1.75:1, such as 1:1 to 1.50:1, such as 1:1 to 1.25:1, such as 1.25:1 to 2.0:1, such as 1.25:1 to 1.75:1, such as 1.25:1 to 1.50:1, such as 1.50:1 to 2.0:1, such as 1.50:1 to 1.75:1.

According to the present disclosure, the electrodepositable coating composition may comprise water and/or one or more organic solvent(s). Water can for example be present in amounts of 40% to 90% by weight, such as 50% to 75% by weight, based on total weight of the electrodepositable coating composition. Examples of suitable organic solvents include oxygenated organic solvents, such as monoalkyl ethers of ethylene glycol, diethylene glycol, propylene glycol, and dipropylene glycol which contain from 1 to 10 carbon atoms in the alkyl group, such as the monoethyl and monobutyl ethers of these glycols. Examples of other at least partially water-miscible solvents include alcohols such as ethanol, isopropanol, butanol and diacetone alcohol. If used, the organic solvents may typically be present in an amount of less than 10% by weight, such as less than 5% by weight, based on total weight of the electrodepositable coating composition. The electrodepositable coating composition may in particular be provided in the form of a dispersion, such as an aqueous dispersion.

According to the present disclosure, the total solids content of the electrodepositable coating composition may be at least 1% by weight, such as at least 5% by weight, and may be no more than 50% by weight, such as no more than 40% by weight, such as no more than 20% by weight, based on the total weight of the electrodepositable coating composition. The total solids content of the electrodepositable coating composition may be from 1% to 50% by weight, such as 5% to 40% by weight, such as 5% to 20% by weight, based on the total weight of the electrodepositable coating composition. As used herein, “total solids” refers to the non-volatile content of the electrodepositable coating composition, i.e., materials which will not volatilize when heated to 110° C. for 15 minutes.

### Substrates

According to the present disclosure, the electrodepositable coating composition may be electrophoretically applied to a substrate. The cationic electrodepositable coating composition may be electrophoretically deposited upon any electrically conductive substrate. Suitable substrates include metal substrates, metal alloy substrates, and/or substrates that have been metallized, such as nickel-plated plastic. Additionally, substrates may comprise non-metal conductive materials including composite materials such as, for example, materials comprising carbon fibers or conductive carbon. According to the present disclosure, the metal or metal alloy may comprise cold rolled steel, hot rolled steel, steel coated with zinc metal, zinc compounds, or zinc alloys, such as electrogalvanized steel, hot-dipped galvanized steel, galvanealed steel, and steel plated with zinc alloy. Aluminum alloys of the 2XXX, 5XXX, 6XXX, or 7XXX series as well as clad aluminum alloys and cast aluminum alloys of the A356 series also may be used as the substrate. Magnesium alloys of the AZ31B, AZ91C, AM60B, or EV31A series also may be used as the substrate. The substrate used in the present disclosure may also comprise titanium and/or titanium alloys. Other suitable non-ferrous metals include copper and magnesium, as well as alloys of these materials. Suitable metal substrates for use in the present disclosure include those that are often used in the assembly of vehicular bodies (e.g., without limitation, door, body panel, trunk deck lid, roof panel, hood, roof and/or stringers, rivets, landing gear components, and/or skins used on an aircraft), a vehicular frame, vehicular parts, motorcycles, wheels, industrial structures and components such as appliances, including washers, dryers, refrigerators, stoves, dishwashers, and the like, agricultural equipment, lawn and garden equipment, air conditioning units, heat pump units, lawn furniture, and other articles. As used herein, “vehicle” or variations thereof includes, but is not limited to, civilian, commercial and military aircraft, and/or land vehicles such as cars, motorcycles, and/or trucks. The metal substrate also may be in the form of, for example, a sheet of metal or a fabricated part. It will also be understood that the substrate may be pretreated with a pretreatment solution including a zinc phosphate pretreatment solution such as, for example, those described in U.S. Pat. Nos. 4,793,867 and 5,588,989, or a zirconium containing pretreatment solution such as, for example, those described in U.S. Pat. Nos. 7,749,368 and 8,673,091.

### Methods of Coating, Coatings and Coated Substrates

The present disclosure is also directed to methods for coating a substrate, such as any one of the electroconductive substrates mentioned above. According to the present disclosure such method may comprise electrophoretically applying an electrodepositable coating composition as described above to at least a portion of the substrate and curing the coating composition to form an at least partially cured coating on the substrate. According to the present disclosure, the method may comprise (a) electrophoretically depositing onto at least a portion of the substrate an electrodepositable coating composition of the present disclosure and (b) heating the coated substrate to a temperature and for a time sufficient to cure the electrodeposited coating on the substrate. According to the present disclosure, the method may optionally further comprise (c) applying directly to the at least partially cured electrodeposited coating one or more pigment-containing coating compositions and/or one or more pigment-free coating compositions to form a topcoat over at least a portion of the at least partially cured electrodeposited coating, and (d) heating the coated substrate of step (c) to a temperature and for a time sufficient to cure the topcoat.

According to the present disclosure, the cationic electrodepositable coating composition of the present disclosure may be deposited upon an electrically conductive substrate by placing the composition in contact with an electrically conductive cathode and an electrically conductive anode, with the surface to be coated being the cathode. Following contact with the composition, an adherent film of the coating composition is deposited on the cathode when a sufficient voltage is impressed between the electrodes. The conditions under which the electrodeposition is carried out are, in general, similar to those used in electrodeposition of other types of coatings. The applied voltage may be varied and can be, for example, as low as one volt to as high as several thousand volts, such as between 50 and 500 volts. The current density may be between 0.5 ampere and 15 amperes per square foot and tends to decrease during electrodeposition indicating the formation of an insulating film.

Once the cationic electrodepositable coating composition is electrodeposited over at least a portion of the electroconductive substrate, the coated substrate is heated to a temperature and for a time sufficient to at least partially cure the electrodeposited coating on the substrate. As used herein, the term “at least partially cured” with respect to a coating refers to a coating formed by subjecting the coating composition to curing conditions such that a chemical reaction of at least a portion of the reactive groups of the components of the coating composition occurs to form a coating. The coated substrate may be heated to a temperature ranging from 250° F. to 450° F. (121.1° C. to 232.2° C.), such as from 275° F. to 400° F. (135° C. to 204.4° C.), such as from 300° F. to 360° F. (149° C. to 180° C.). The curing time may be dependent upon the curing temperature as well as other variables, for example, the film thickness of the electrodeposited coating, level and type of catalyst present in the composition and the like. For purposes of the present disclosure, all that is necessary is that the time be sufficient to effect cure of the coating on the substrate. For example, the curing time can range from 10 minutes to 60 minutes, such as 20 to 40 minutes. The thickness of the resultant cured electrodeposited coating may range from 15 to 50 microns.

According to the present disclosure, the anionic electrodepositable coating composition of the present disclosure may be deposited upon an electrically conductive substrate by placing the composition in contact with an electrically conductive cathode and an electrically conductive anode, with the surface to be coated being the anode. Following contact with the composition, an adherent film of the coating composition is deposited on the anode when a sufficient voltage is impressed between the electrodes. The conditions under which the electrodeposition is carried out are, in general, similar to those used in electrodeposition of other types of coatings. The applied voltage may be varied and can be, for example, as low as one volt to as high as several thousand volts, such as between 50 and 500 volts. The current density may be between 0.5 ampere and 15 amperes per square foot and tends to decrease during electrodeposition indicating the formation of an insulating film.

Once the anionic electrodepositable coating composition is electrodeposited over at least a portion of the electroconductive substrate, the coated substrate may be heated to a temperature and for a time sufficient to at least partially cure the electrodeposited coating on the substrate. As used herein, the term “at least partially cured” with respect to a coating refers to a coating formed by subjecting the coating composition to curing conditions such that a chemical reaction of at least a portion of the reactive groups of the components of the coating composition occurs to form a coating. The coated substrate may be heated to a temperature ranging from 200° F. to 450° F. (93° C. to 232.2° C.), such as from 275° F. to 400° F. (135° C. to 204.4° C.), such as from 300° F. to 360° F. (149° C. to 180° C.). The curing time may be dependent upon the curing temperature as well as other variables, for example, film thickness of the electrodeposited coating, level and type of catalyst present in the composition and the like. For purposes of the present disclosure, all that is necessary is that the time be sufficient to effect cure of the coating on the substrate. For example, the curing time may range from 10 to 60 minutes, such as 20 to 40 minutes. The thickness of the resultant cured electrodeposited coating may range from 15 to 50 microns.

The electrodepositable coating compositions of the present disclosure may also, if desired, be applied to a substrate using non-electrophoretic coating application techniques, such as flow, dip, spray and roll coating applications. For non-electrophoretic coating applications, the coating compositions may be applied to conductive substrates as well as non-conductive substrates such as glass, wood and plastic.

The present disclosure is further directed to a coating formed by at least partially curing the electrodepositable coating composition described herein.

The present disclosure is further directed to a substrate that is coated, at least in part, with the electrodepositable coating composition described herein in an at least partially cured state. The coated substrate may comprise a coating comprising an addition polymer comprising a polymerization product of a polymeric dispersant and a second stage ethylenically unsaturated monomer composition comprising a second stage (meth)acrylamide monomer; an ionic salt group-containing film-forming polymer different from the addition polymer; and a curing agent. The coated substrate may comprise a coating comprising an addition polymer comprising a polymerization product of a polymeric dispersant and a second stage ethylenically unsaturated monomer composition comprising at least 20% by weight of a second stage hydroxyl-functional (meth)acrylamide monomer, based on the total weight of the second stage ethylenically unsaturated monomer composition; an ionic salt group-containing film-forming polymer different from the addition polymer; and a curing agent.

### Multi-Layer Coating Composites

The electrodepositable coating compositions of the present disclosure may be utilized in an electrocoating layer that is part of a multi-layer coating composite comprising a substrate with various coating layers. The coating layers may include a pretreatment layer, such as a phosphate layer (e.g., zinc phosphate layer), an electrocoating layer which results from the aqueous resinous dispersion of the present disclosure, and suitable topcoat layers (e.g., base coat, clear coat layer, pigmented monocoat, and color-plus-clear composite compositions). It is understood that suitable topcoat layers include any of those known in the art, and each independently may be waterborne, solventborne, in solid particulate form (i.e., a powder coating composition), or in the form of a powder slurry. The topcoat typically includes a film-forming polymer, crosslinking material and, if a colored base coat or monocoat, one or more pigments. According to the present disclosure, the primer layer is disposed between the electrocoating layer and the base coat layer. According to the present disclosure, one or more of the topcoat layers are applied onto a substantially uncured underlying layer. For example, a clear coat layer may be applied onto at least a portion of a substantially uncured basecoat layer (wet-on-wet), and both layers may be simultaneously cured in a downstream process.

Moreover, the topcoat layers may be applied directly onto the electrodepositable coating layer. In other words, the substrate lacks a primer layer. For example, a basecoat layer may be applied directly onto at least a portion of the electrodepositable coating layer.

It will also be understood that the topcoat layers may be applied onto an underlying layer despite the fact that the underlying layer has not been fully cured. For example, a clearcoat layer may be applied onto a basecoat layer even though the basecoat layer has not been subjected to a curing step. Both layers may then be cured during a subsequent curing step thereby eliminating the need to cure the basecoat layer and the clearcoat layer separately.

According to the present disclosure, additional ingredients such as colorants and fillers may be present in the various coating compositions from which the topcoat layers result. Any suitable colorants and fillers may be used. For example, the colorant may be added to the coating in any suitable form, such as discrete particles, dispersions, solutions and/or flakes. A single colorant or a mixture of two or more colorants can be used in the coatings of the present disclosure. It should be noted that, in general, the colorant can be present in a layer of the multi-layer composite in any amount sufficient to impart the desired property, visual and/or color effect.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant may be organic or inorganic and may be agglomerated or non-agglomerated. Colorants may be incorporated into the coatings by grinding or simple mixing. Colorants may be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPP red BO”), titanium dioxide, carbon black, zinc oxide, antimony oxide, etc. and organic or inorganic UV opacifying pigments such as iron oxide, transparent red or yellow iron oxide, phthalocyanine blue and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

The colorant may be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions may include colorants such as pigments or dyes having a particle size of less than 150 nm, such as less than 70 nm, or less than 30 nm. Nanoparticles may be produced by milling stock organic or inorganic pigments with grinding media having a particle size of less than 0.5 mm Example nanoparticle dispersions and methods for making them are identified in U.S. Pat. No. 6,875,800 B2, which is incorporated herein by reference. Nanoparticle dispersions may also be produced by crystallization, precipitation, gas phase condensation, and chemical attrition (i.e., partial dissolution). In order to minimize re-agglomeration of nanoparticles within the coating, a dispersion of resin-coated nanoparticles may be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. patent application Ser. No. 10/876,031 filed Jun. 24, 2004, which is incorporated herein by reference, and U.S. Provisional Pat. Application No. 60/482,167 filed Jun. 24, 2003, which is also incorporated herein by reference.

According to the present disclosure, special effect compositions that may be used in one or more layers of the multi-layer coating composite include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions may provide other perceptible properties, such as reflectivity, opacity or texture. For example, special effect compositions may produce a color shift, such that the color of the coating changes when the coating is viewed at different angles. Example color effect compositions are identified in U.S. Pat. No. 6,894,086, incorporated herein by reference. Additional color effect compositions may include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

According to the present disclosure, a photosensitive composition and/or photochromic composition, which reversibly alters its color when exposed to one or more light sources, can be used in a number of layers in the multi-layer composite. Photochromic and/or photosensitive compositions can be activated by exposure to radiation of a specified wavelength. When the composition becomes excited, the molecular structure is changed, and the altered structure exhibits a new color that is different from the original color of the composition. When the exposure to radiation is removed, the photochromic and/or photosensitive composition can return to a state of rest, in which the original color of the composition returns. For example, the photochromic and/or photosensitive composition may be colorless in a non-excited state and exhibit a color in an excited state. Full color-change may appear within milliseconds to several minutes, such as from 20 seconds to 60 seconds. Example photochromic and/or photosensitive compositions include photochromic dyes.

According to the present disclosure, the photosensitive composition and/or photochromic composition may be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with the present disclosure, have minimal migration out of the coating. Example photosensitive compositions and/or photochromic compositions and methods for making them are identified in U.S. patent application Ser. No. 10/892,919 filed Jul. 16, 2004 and incorporated herein by reference.

For purposes of this detailed description, it is to be understood that the disclosure may assume alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

In this application, the use of the singular includes the plural and plural encompasses singular, unless specifically stated otherwise. For example, although reference is made herein to “an” ionic salt group-containing film-forming polymer, “an” addition polymer, “a” polymeric dispersant, “a” monomer, a combination (i.e., a plurality) of these components may be used. In addition, in this application, the use of “or” means “and/or” unless specifically stated otherwise, even though “and/or” may be explicitly used in certain instances.

Whereas specific aspects of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

Illustrating the disclosure are the following examples, which, however, are not to be considered as limiting the disclosure to their details. Unless otherwise indicated, all parts and percentages in the following examples, as well as throughout the specification, are by weight.

### EXAMPLES

### Example 1

### Preparation of a Blocked Polyisocyanate Crosslinker for Electrodepositable Coating Compositions (Crosslinker I)

A blocked polyisocyanate crosslinker (Crosslinker I), suitable for use in electrodepositable coating resins, was prepared in the following manner Components 2-5 listed in Table 1, below, were mixed in a flask set up for total reflux with stirring under nitrogen. The mixture was heated to a temperature of 35° C., and Component 1 was added dropwise so that the temperature increased due to the reaction exotherm and was maintained under 100° C. After the addition of Component 1 was complete, a temperature of 110° C. was established in the reaction mixture and the reaction mixture held at temperature until no residual isocyanate was detected by IR spectroscopy. Component 6 was then added, and the reaction mixture was allowed to stir for 30 minutes and cooled to ambient temperature.

TABLE 1

| | | Parts-by-weight |
|---|---|---|
| No. | Component | (grams) |
| 1 | Polymeric methylene diphenyl diisocyanate ¹ | 1340.00 |
| 2 | Dibutyltin dilaurate | 2.61 |
| 3 | Methyl isobutyl ketone | 234.29 |
| 4 | Diethylene glycol monobutyl ether | 324.46 |
| 5 | Ethylene glycol monobutyl ether | 945.44 |
| 6 | Methyl isobutyl ketone | 88.60 |

¹ Rubinate M, available from Huntsman Corporation

### Example 2

### Preparation of a Cationic, Amine-Functionalized, Polyepoxide-Based Resin Without Additives (Resin Dispersion A)

A cationic, amine-functionalized, polyepoxide-based polymeric resin, suitable for use in formulating electrodepositable coating compositions, was prepared in the following manner Components 1-5 listed in Table 2, below, were mixed in a flask set up for total reflux with stirring under nitrogen. The mixture was heated to a temperature of 130° C. and allowed to exotherm (175° C. maximum). A temperature of 145° C. was established in the reaction mixture and the reaction mixture was then held for 2 hours. Component 6 was introduced while allowing the mixture to cool to 125° C. followed by the addition of

Components 7 and 8. Components 9 and 10 were then added to the reaction mixture quickly and the reaction mixture was allowed to exotherm. A temperature of 122° C. was established and the reaction mixture held for 1 hour, resulting in Resin Synthesis Product A.

TABLE 2

| | | |
|---|---|---|
| | | Parts-by-weight |
| No. | Component | (grams) |

Resin Synthesis Stage

| | | |
|---|---|---|
| 1 | Bisphenol A diglycidyl ether¹ | 583.94 |
| 2 | Bisphenol A | 252.15 |
| 3 | Bisphenol A - ethylene oxide adduct | 118.75 |
| | (1/6 molar ratio BPA/EtO) | |
| 4 | Methyl isobutyl ketone (MIBK) | 29.53 |
| 5 | Ethyl triphenyl phosphonium iodide | 0.57 |
| 6 | Bisphenol A - ethylene oxide adduct | 118.75 |
| | (1/6 molar ratio BPA/EtO) | |
| 7 | Methyl isobutyl ketone | 116.25 |
| 8 | Crosslinker I² | 683.69 |
| 9 | Diethylene triamine - MIBK diketimine³ | 54.16 |
| 10 | Methyl ethanol amine | 46.24 |

Resin Dispersion Stage

| | | |
|---|---|---|
| 11 | Resin Synthesis Product A | 1803.63 |
| 12 | Sulfamic acid | 38.50 |
| 13 | Deionized water | 1093.72 |
| 14 | Gum rosin solution in butyl | 15.69 |
| | carbitol formal (30 wt %) | |
| 15 | Deionized water | 1320.42 |
| 16 | Deionized water | 1100.00 |

¹EPON 828, available from Hexion Corporation.
²See Example 1, above.
³72.7% by weight (in MIBK) of the diketimine reaction product of 1 equivalent of diethylene triamine and 2 equivalents of MIBK.

A portion of the Resin Synthesis Product A (Component 11) was then poured into a pre-mixed solution of Components 12 and 13 to form a resin dispersion. Component 14 was then added quickly, and the resin dispersion was stirred for 1 hour. Component 15 was then introduced over 30 minutes to further dilute the resin dispersion, followed by the addition of Component 16. The free MIBK in the resin dispersion was removed from the dispersion under vacuum at a temperature of 60-70° C.

The solids content of the resulting cationic, amine-functionalized, polyepoxide-based polymeric resin dispersion (Resin Dispersion A) was determined by adding a quantity of the resin dispersion to a tared aluminum dish, recording the initial weight of the resin dispersion, heating the resin dispersion in the dish for 60 minutes at 110° C. in an oven, allowing the dish to cool to ambient temperature, reweighing the dish to determine the amount of non-volatile content remaining, and calculating the solids content by dividing the weight of the remaining non-volatile content by the initial resin dispersion weight and multiplying by 100. (Note, this procedure was used to determine the solids content in each of resin dispersion examples described below). The Resin Dispersion A had a solids content of 38.79% by weight.

### Example 3

### Preparation of a Cationic Resin Containing Jeffamine D400 (Cationic Resin B)

TABLE 3

| No. | Component | Parts-by-weight (grams) |
|---|---|---|
| 1 | DER 732¹ | 642.00 |
| 2 | Bisphenol A diglycidyl ether² | 376.00 |
| 3 | Bisphenol A | 342.00 |
| 4 | Benzyldimethyl Amine | 1.50 |
| 5 | Butyl Carbitol Formal | 178.84 |
| 6 | Methoxypropanol | 46.63 |
| 7 | Diethanol Amine | 31.56 |
| 8 | N-Methyl Ethanol Amine | 2.45 |
| 9 | JEFFAMINE D400³ | 218.00 |
| 10 | Lactic Acid | 40.61 |
| 11 | Deionized Water | 1695.15 |
| 12 | Deionized water | 682.23 |

¹Aliphatic epoxy resin available from Dow Chemical Co.
²EPON 828, available from Hexion Corporation.
³A polypropylene oxide resin terminated with primary amines available from Huntsman Chemical

A cationic resin was prepared in the following manner from the materials included in Table 3: Materials 1-3 were added to a suitably equipped round bottom flask. The mixture was then heated to 130° C. and material 4 was introduced. The reaction mixture was allowed to exotherm and held at 135 ° C. until the epoxy equivalent weight of 1361 was achieved. Components 5-6 were then introduced while cooling the content of the flask to 98° C. Components 7-8 were added to the flask and held for 30 min, followed by the addition of Component 9. The reaction mixture was allowed to exotherm and held at 90-95° C. until a stable Gardner-Holdt viscosity of G-K was attained (10 g of the reaction mixture in 8.7 g of 1-methoxy-2-propanol). Components 9-10 were then introduced, and the reaction mixture held at 90-95° C. until a Gardner-Holdt viscosity was achieved. The content of the flask was solubilized into pre-blended Charges 10-11 and mixed for 30 min. Charge 12 was then introduced, and the resulting dispersion mixed for additional 30 minutes. The resulting Cationic Resin Dispersion B has a solids content of 41.32%.

### Example 4

### Synthesis of a Cationic Salt Group-Containing Polymeric Dispersant C

TABLE 4

| Charge # | Material | Amount (g) |
|---|---|---|
| 1 | Dowanol ™ PnB | 65.0 |
| | Dowanol ™ PM | 83.5 |
| | Butyl Cellosolve | 198.5 |
| | Deionized Water | 13.9 |
| 2 | Ethyl Acrylate | 353.4 |
| | Styrene | 62.1 |
| | 2-Hydroxypropyl Methacrylate | 93.0 |
| | Methyl Methacrylate | 260.4 |
| | Glycidyl Methacrylate | 139.5 |
| | Allyl Methacrylate | 11.5 |
| | t-Dodecyl Mercaptan | 9.3 |
| 3 | Vazo ™ 67¹ | 18.5 |
| | Dowanol ™ PnB | 29.5 |
| | Dowanol ™ PM | 14.8 |
| | Methyl Isobutyl Ketone | 11.8 |
| 4 | Lupersol 7M50 | 18.6 |
| | Dowanol ™ PnB | 14.8 |
| | Dowanol ™ PM | 7.4 |
| 5 | Butyl Cellosolve | 80.3 |
| 6 | Diethanol amine | 99.6 |
| 7 | Deionized Water | 3334.0 |
| | Formic Acid (90% in water) | 34.2 |
| 8 | Deionized water | 1151.5 |

¹2,2′-azobis(2-methylbutyronitrile) free radical initiator available from The Chemours Company.

A cationic salt group-containing polymeric dispersant was prepared from the components listed in Table 4 according to the following procedure: Charge 1 was added to a 4-necked flask fitted with a thermocouple, nitrogen sparge, and a mechanical stirrer. Under a nitrogen blanket and agitation, the flask was heated to reflux with a temperature set point of 100° C. Charges 2 and 3 were added dropwise from an addition funnel over 150 minutes followed by a 30-minute hold. After increasing the temperature to 120° C., charge 4 was subsequently added over 15 minutes followed by a 10-minute hold. The temperature was decreased to 110° C. while adding charge 5 to help cool the reaction. Charge 6 was added, and the temperature was held at 115° C. for 3 hours. During the hold, charge 7 was heated to approximately 35-40° C. in a separate container outfitted with a mechanical stirrer. After the hold, the contents from the reactor were poured into the container that includes charge 7 under rapid agitation and then held for 60 minutes. Charge 8 was added under agitation as the dispersion continued to cool to ambient temperature (about 25° C.). The resulting aqueous dispersion of the cationic polymeric dispersant had a solids content of 16.70%.

The weight average molecular weight (Mw) and z-average molecular weight (Mz) were determined by Gel Permeation Chromatography (GPC). For polymers having a z-average molecular weight of less than 900,000, GPC was performed using a Waters 2695 separation module with a Waters 410 differential refractometer (RI detector), polystyrene standards having molecular weights of from approximately 500 g/mol to 900,000 g/mol, dimethylformamide (DMF) with 0.05 M lithium bromide (LiBr) as the eluent at a flow rate of 0.5 mL/min, and one Asahipak GF-510 HQ column for separation. With respect to polymers having a z-average molecular weight (Mz) of greater than 900,000 g/mol, GPC was performed using a Waters 2695 separation module with a Waters 410 differential refractometer (RI detector), polystyrene standards having molecular weights of from approximately 500 g/mol to 3,000,000 g/mol, dimethylformamide (DMF) with 0.05 M lithium bromide (LiBr) as the eluent at a flow rate of 0.5 mL/min, and one Asahipak GF-7M HQ column for separation. This procedure was followed for all of the molecular weight measurements included in the Examples. It was determined that the cationic polymeric dispersant had a weight average molecular weight of 207,774 g/mol, and a z-average molecular weight of 1,079,872 g/mol.

### Example 5

### Synthesis of a Comparative Addition Polymer D

TABLE 5

| Charge # | Material | Amount (g) |
|---|---|---|
| 1 | Product of Example 4 (cationic salt | 726.1 |
| | group-containing polymeric dispersant) | |
| | Deionized Water | 680.1 |
| 2 | Ethyl Acrylate | 87.6 |
| | Styrene | 93.8 |
| | 2-Hydroxypropyl Methacrylate | 20.9 |
| | Trimethylolpropane triacrylate | 6.2 |
| 3 | Deionized Water | 26.7 |
| | Hydrogen Peroxide | 3.2 |
| | (35% in Deionized Water) | |
| 4 | Iso-Ascorbic Acid | 0.6 |
| | Ferrous Ammonium Sulfate | 0.006 |
| | Deionized Water | 43.6 |
| 5 | Deionized Water | 5.0 |
| | Hydrogen Peroxide | 0.09 |
| | (35% in Deionized Water) | |
| 6 | Iso-Ascorbic Acid | 0.09 |
| | Deionized Water | 5.0 |

An aqueous dispersion of Comparative Addition Polymer D was formed from the ingredients included in Table 5. Comparative Addition Polymer D includes the cationic polymeric dispersant and an ethylenically unsaturated monomer composition having 10% by weight of a hydroxyl-functional (meth)acrylate (2-hydroxypropyl methacrylate), based on the weight of the ethylenically unsaturated monomer composition. The Comparative Addition Polymer D was prepared as follows: Charge 1 was added to a 4-necked flask fitted with a thermocouple, nitrogen sparge, and a mechanical stirrer. Under a nitrogen blanket and rigorous stirring, the flask was heated to 25° C. At 25° C., the solution was sparged under nitrogen for an additional 30 minutes. Charge 2 was then added to the reaction vessel over 10 minutes. Charge 3 was then added to the reaction vessel over 2-3 minutes. The components of charge 4 were mixed together and added to the reactor through an addition funnel over 30 minutes. The reaction was allowed to exotherm during the addition of charge 4. After the addition was complete, the reactor was heated to 50° C. and held at that temperature for 30 minutes. Charges 5 and 6 were added dropwise and held for 30 minutes at 50° C. The reactor was then cooled to ambient temperature.

The solids content of the resulting aqueous dispersion of Comparative Addition Polymer D was determined using the method described in Example 2. The measured solids content was 19.23%. The weight average molecular weight of Comparative Addition Polymer D was 655,838 g/mol and the z-average molecular weight of Comparative Addition Polymer D was 1,395,842 g/mol, as measured according to the method described in Example 4.

### Example 6

### Synthesis of Experimental Addition Polymers E-L

TABLE 6

| Addition Polymer | | Comp. E | F | K |
|---|---|---|---|---|
| Charge # | Material | Amount (g) | | |
| 1 | Product of Example 4 | 711.43 | 711.43 | 1418.70 |
| | (cationic salt | | | |
| | group-containing | | | |
| | polymeric dispersant) | | | |
| | Deionized Water | 1574.08 | 1574.08 | 1103.04 |
| 2 | 2-Hydroxyethyl Acrylate | 208.49 | — | — |
| | 2-Hydroxyethyl Acrylamide | — | 208.49 | 208.49 |
| | SIPOMER PAM-200¹ | — | — | — |
| 3 | Deionized Water | 61.80 | 61.80 | 53.10 |
| | Hydrogen Peroxide (35% in | 3.16 | 3.16 | 3.16 |
| | Deionized Water) | | | |
| 4 | Iso-Ascorbic Acid | 0.58 | 0.58 | 0.58 |
| | Ferrous Ammonium Sulfate | 0.01 | 0.01 | 0.01 |
| | Deionized Water | 88.54 | 88.54 | 92.83 |
| 5 | Deionized Water | 20.86 | 20.86 | 17.86 |
| | Hydrogen Peroxide (35% in | 0.09 | 0.09 | 0.09 |
| | Deionized Water) | | | |
| 6 | Iso-Ascorbic Acid | 0.09 | 0.09 | 0.09 |
| | Deionized Water | 21.19 | 21.19 | 18.1 |

Measured Solids (wt %)

| | | |
|---|---|---|
| 12.62 | 12.84 | 16.28 |

¹Phosphorous acid-functional ethylenically unsaturated monomer available from Solvay.

TABLE 7

| Addition Polymer | | G | H | I | J | L |
|---|---|---|---|---|---|---|
| Charge # | Material | Amount (g) | | | | |
| 1 | Product of Example 4 | 728.41 | 728.41 | 728.41 | 727.17 | 711.4 |
| | (cationic salt group- | | | | | |
| | containing polymeric | | | | | |
| | dispersant) | | | | | |
| | Deionized Water | 1504.98 | 1452.86 | 1400.73 | 1349.85 | 1574.1 |
| 2 | 2-Hydroxyethyl | 156.37 | 104.25 | 52.12 | — | 204.3 |
| | Acrylamide | | | | | |
| | Acrylamide (50% in | 104.25 | 208.49 | 312.74 | 416.98 | — |
| | water) | | | | | |
| | SIPOMER PAM-200¹ | — | — | — | — | 4.2 |
| 3 | Deionized Water | 61.80 | 61.80 | 61.80 | 61.80 | 61.8 |
| | Hydrogen Peroxide | 3.16 | 3.16 | 3.16 | 3.16 | 3.16 |
| | (35% in Deionized | | | | | |
| | Water) | | | | | |
| 4 | Iso-Ascorbic Acid | 0.58 | 0.58 | 0.58 | 0.58 | 0.58 |
| | Ferrous Ammonium | 0.01 | 0.01 | 0.01 | 0.01 | 0.01 |
| | Sulfate | | | | | |
| | Deionized Water | 88.54 | 88.54 | 88.54 | 88.54 | 88.54 |
| 5 | Deionized Water | 20.86 | 20.86 | 20.86 | 20.86 | 20.86 |
| | Hydrogen Peroxide | 0.09 | 0.09 | 0.09 | 0.09 | 0.09 |
| | (35% in Deionized | | | | | |
| | Water) | | | | | |
| 6 | Iso-Ascorbic Acid | 0.09 | 0.09 | 0.09 | 0.09 | 0.09 |
| | Deionized Water | 21.19 | 21.19 | 21.19 | 21.19 | 21.19 |

Measured Solids (wt %)

| | | | | |
|---|---|---|---|---|
| 13.01 | 13.13 | 13.26 | 13.58 | 13.50 |

¹Phosphorous acid-functional ethylenically unsaturated monomer available from Solvay.

Aqueous dispersions of comparative addition polymer E and experimental addition polymers F-L was obtained according to the formulations disclosed in Tables 6-7. To prepare the dispersion, charge 1 was added to a 4-necked flask fitted with a thermocouple, nitrogen sparge, and a mechanical stirrer. Under a nitrogen blanket and rigorous stirring, the flask was heated to 25° C. At 25° C., the solution was sparged with nitrogen for an additional 30 minutes. Charge 2 was added to the reaction vessel over 10 minutes. Charge 3 was introduced to the reaction vessel over 2-3 minutes. Charge 4 was mixed together and added through an addition funnel over 30 minutes. The reaction was allowed to exotherm during the addition. After the addition was complete, the reactor was heated to 50° C. and held at that temperature for 30 minutes. Charges 5 and 6 were added dropwise and held for 30 minutes at 50° C. The reaction was then cooled to ambient temperature.

### Example 8

### Preparation of Surfactant Blend A

Charges 1-4 were added to a ½ gallon container and blended to form the surfactant blend A and will be referred to throughout the coating compositions. Charges 1 through 4 were blended sequentially.

TABLE 8

| Material # | Description | Parts by Weight |
|---|---|---|
| 1 | 2-butoxyethanol | 31.26 |
| 2 | Surfynol 104 | 31.26 |
| 3 | Amine C¹ | 32.46 |
| 4 | 75% Acetic acid in Water | 5.01 |

¹4,5-Dihydro-1H-Imidazole-1-ethanol available from Ciba Geigy

### Example 9

### Preparation of Comparative Electrodepositable Coating Compositions A and B

TABLE 9

| | | Amount | |
|---|---|---|---|
| | | Composition A | Composition B |
| Charge # | Material | (grams) | (grams) |
| 1 | Resin A | 690.55 | 690.55 |
| 2 | Resin B | 89.10 | 89.10 |
| 3 | Surfactant Blend A | 1.68 | 1.68 |
| 4 | Butyl carbitol formal¹ | 12.42 | 12.42 |
| 5 | DI Water | 245.25 | 245.25 |
| 6 | Comp. Addition Polymer D | 0 | 17.34 |
| 7 | Pigment Paste² | 162.50 | 162.50 |
| 8 | DI Water | 780.00 | 780.00 |

¹MAZON 1651 available from BASF Corporation
²Pigment paste E6476 commercially sold by PPG

Charges 1-5 were added to a plastic container stirred for 15 minutes from Table 9. Charge 6 was then added and stirred for an additional 10 minutes. The pigment paste and DI water were added and stirred for a minimum of 1 hour. The sub-total of charges 1-6 represents the total weight of resin blend. The bath composition had a solids content of 21.5% and a pigment to binder ratio of 0.12/1.0 by weight.

After 20% ultrafiltration (and reconstitution with deionized water), coated panels were prepared from a bath containing the cationic electrodepositable coating composition.

### Evaluation of Comparative Electrodepositable Coating Compositions A and B

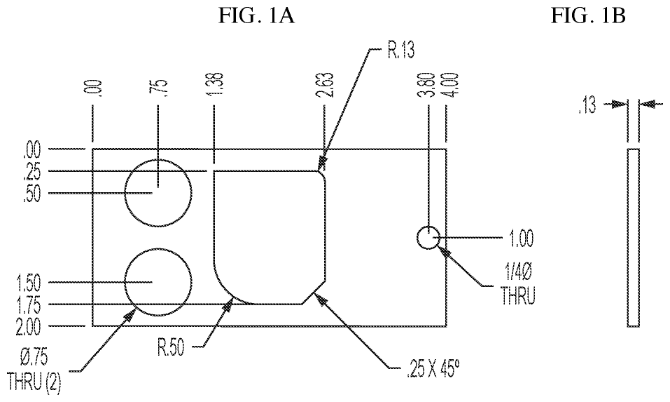

Evaluation of edge coverage: Laser-cut hot rolled steel panels available from Alle Kiski Industries having the dimensions in inches as shown in FIG. 1A and a thickness of 0.13 inch as shown in FIG. 1B were pretreated with CHEMFOS C700 (commercially available from PPG Industries, Inc.), and then were coated by a manner well known in the art by immersing them into a stirring bath containing the electrodepositable coating composition heated to 90° F. (32.2° C.) and connecting the cathode of direct current rectifier to the substrate and connecting the rectifier's anode to the stainless steel tubing used to circulate cooling water for bath temperature control. The voltage was increased from 0 to a set point voltage of 190V over a period of 30 seconds and then held at that voltage for an additional 20-120 seconds for the desired film thickness. This combination of time, temperature, and voltage deposited a coating having a dry film thickness of 20 microns once cured. After electrodeposition, the panels were removed from the bath, rinsed vigorously with deionized water, and cured at 177° C. for 30 minutes in a Despatch LPD 1-42 electric oven.

The beverage can industry measures coverage of the thin coating inside a can using a WACO Enamel Rater instrument, which measures current flow through a 1% sodium chloride solution in an operating range from 0 to 500 milliamperes, when a 6.2-voltpotential difference is applied between the outside of the can and a stainless-steel anode placed in the center of the salt solution (electrolyte) inside the can. The greater the coating coverage, the lower the current passed. This method was adopted for use in evaluating the laser cut panels with sharp edges, and the procedure is defined as the Enamel Rating Procedure herein. Specifically, hot rolled steel parts were used that were pre-treated with CHEMFOS C700 (commercially available from PPG Industries) with a DI rinse. As noted above, the exact geometry of the panel shown in FIG. 1. Instead of a can being the tested work piece, a stainless-steel beaker becomes the cathode and the test piece, the coated part, is electrically connected to the anode and the part is lowered into the 1% sodium chloride solution to a depth of 2.5 inches from the tip of the laser cut part, so that a fixed surface area of part is below the surface of the electrolyte. A 6.2-volt potential difference is applied between the stainless-steel beaker and the coated laser cut panel and the amount of current passed is an indication of the extent of coverage of the laser cut part with the electrodeposited coating.

The coated laser cut part were visually inspected for evidence of defects (e.g., pinholes) and only those which had no defects on the coated front, back and back edges, were selected for testing. As a result, the current passed is a reflection of the degree of coverage of the electrodeposited coating on the sharp edge of the laser cut part with a coating thickness between 19-21 microns. Since there is some variation from part to part, current measurements were taken on three separate parts and the results were averaged. Enamel rater results are also reported in Table 10. This test method is referred to herein as the Enamel Rating Procedure.

Evaluation of appearance and crater resistance: Cold rolled steel panels having dimensions of 4×12×0.031 inches and pretreated with CHEMFOS C700 (commercially available from PPG Industries) followed by a DI water rinse, available from ACT Laboratories (Item #28360) were used. The panels were cut in half to form test panels having dimensions of 4×6×0.031 inches. The test panels were coated by the same method as described above and used to evaluate appearance and crater resistance.

Appearance measurements of the surface roughness were taken on the panels using a Mitutoyo Surftest SJ-402 skidless stylus profilometer having a cut-off value of 2.5 mm Three different areas of the cured coating spaced approximately evenly across the length of the panel were measured and averaged to report a Ra value. Ra values for compositions A and B are reported in Table 10.

The coated test panels were also tested for oil spot contamination resistance, which evaluates the ability of an electrodeposited coating to resist crater formation upon cure. The electrodeposited coating layers were tested for oil spot crater resistance by localized contamination of the test panel prior to coating and subsequently evaluating the cured coating layers at the spots of contamination using three common oils: Ferrocote 6130 (Quaker Chemical Corporation, F), LubeCon Series O Lubricant (Castrol Industrial North America Inc., L) or Molub-Alloy Chain Oil 22 Spray (Castrol Industrial North America Inc., M). The oil was deposited as a droplet (<0.15 μL) onto the dried coating layers using a 40% by weight solution of the LubeCon Series 0 Lubricant in isopropanol, a 40% by weight solution of the or Molub-Alloy Chain Oil 22 Spray in isopropanol, or a 40% by weight solution of Ferrocote 6130 in isopropanol/butanol (75%/25% by weight) and a micropipette (Scilogex). The oil-spotted substrate panels were then cured as described above (baked for 30 minutes at 177° C. in an electric oven). A quantitative measure of crater depth was performed by scanning the coated panel using a Mitutoyo Surftest SJ-402 skidless stylus profilometer to examine the topography of crater defects in the cured coating layer. From the scanned profile of the crater, the highest point of the crater rim and lowest point of depth of each of the craters were measured on each side of the crater and the difference determined to determine crater depth. Five craters are applied for each panel and at least four different craters are measured for each oil. A crater is omitted if the oil wet out into the film, rather than forming a crater. Oil spot resistance values for the various oils are reported in Table 10. This test procedure is referred to herein as the Crater Resistance Test Method.

TABLE 10

| | | Additive | | | | | |
|---|---|---|---|---|---|---|---|
| | | amount (% of | Enamel | | Oil Spot Resistance Crater Size | | |
| Coating | Additive | resin blend | Rater | Ra | (Δ, μm) | | |
| Comp. | Example | solids) | (mA) | (μm) | L | F | M |
| Comp. | None | 0% | 427 | 0.148 | 13.94 | 16.69 | 18.64 |
| A | | | | | | | |
| Comp. | Polymer D | 1.0% | >500 | 0.197 | 11.39 | 13.84 | 14.83 |
| B | | | | | | | |

### Example 10

### Preparation of Electrodepositable Coating Compositions C-J

Charges 1-5 were added to a plastic container stirred for 15 minutes from Table 11. Charges 7-9 was then added and stirred for an additional 10 minutes. The pigment paste and DI water were added and stirred for a minimum of 1 hour. The sub-total of charges 1-9 represents the total weight of resin blend. The bath composition had a solids content of 21.5% and a pigment to binder ratio of 0.12/1.0 by weight.

To evaluate the stability of Polymers E and F (the resins used in charges 6-9), some of each of these polymers were placed in sealed glass jars, placed in a dark, hot room and stored at 160° F. (71.1° C.) for 2 weeks prior to addition to the electrodepositable coating composition. These will be defined as “non-aged” (i.e., polymers not subjected to storage in hot room) versus “aged” (i.e., polymers subjected to storage in the hot room) throughout the example.

TABLE 11

| | | Amount | | | |
|---|---|---|---|---|---|
| | | Compo- | Compo- | Compo- | Compo- |
| | | sition C | sition D | sition E | sition F |
| Charge # | Material | (grams) | (grams) | (grams) | (grams) |
| 1 | Resin A | 690.55 | 690.55 | 690.55 | 690.55 |
| 2 | Resin B | 89.10 | 89.10 | 89.10 | 89.10 |
| 3 | Surfactant | 1.68 | 1.68 | 1.68 | 1.68 |
| | Blend A | | | | |
| 4 | Butyl carbitol | 12.42 | 12.42 | 12.42 | 12.42 |
| | formal¹ | | | | |
| 5 | DI Water | 245.25 | 245.25 | 245.25 | 245.25 |
| 6 | Polymer E | 13.15 | — | — | — |
| | (non-aged) | | | | |
| 7 | Polymer E | — | 13.15 | — | — |
| | (aged) | | | | |
| 8 | Polymer F | — | — | 12.84 | — |
| | (non-aged) | | | | |
| 9 | Polymer F | — | — | — | 12.84 |
| | (aged) | | | | |
| 10 | Pigment Paste² | 162.50 | 162.50 | 162.50 | 162.50 |
| 11 | DI Water | 780.00 | 780.00 | 780.00 | 780.00 |

¹MAZON 1651 available from BASF Corporation
²Pigment paste E6476 commercially sold by PPG

Compositions G-J were prepared by adding additional amounts of non-aged or aged Polymer E or F to the baths of electrodepositable coating compositions C-F to increase the level of Polymer E and F in the resulting compositions from 0.5% to 1.0%, as shown in Table 12, after electrodepositable coating composition C-F were coated out as described below. The resulting compositions were stirred for a minimum of 10 minutes prior to electrocoating.

TABLE 12

| | | Amount | | | |
|---|---|---|---|---|---|
| | | Compo- | Compo- | Compo- | Compo- |
| Charge # | Material | sition G | sition H | sition I | sition J |
| 1 | Composition C | 1994.65 | — | — | — |
| 2 | Composition D | — | 1994.65 | — | — |
| 3 | Composition E | — | — | 1994.65 | — |
| 4 | Composition F | — | — | — | 1994.65 |
| 5 | Polymer E | 13.15 | — | — | — |
| | (non-aged) | | | | |
| 6 | Polymer E | — | 13.15 | — | — |
| | (aged) | | | | |
| 7 | Polymer F | — | — | 12.84 | — |
| | (non-aged) | | | | |
| 8 | Polymer F | — | — | — | 12.84 |
| | (aged) | | | | |

### Evaluation of Coating Compositions C-J

After 20% ultrafiltration (and reconstitution with deionized water), coated panels were prepared from a bath containing one of the cationic electrodepositable coating composition examples by the same method as set forth above for Comparative Examples A and B with the same two types of panels identified above.

The coated panels were evaluated for appearance, edge coverage, and crater resistance using the same methods describe above in Comparative Examples A and B. The results for electrodepositable coating compositions C-J are reported in Table 13.

TABLE 13

| | | | Additive | | | | | |
|---|---|---|---|---|---|---|---|---|
| | | | amount | | | | | |
| | | | (% of | | | | | |
| | | | resin | Enamel | | Oil Spot Resistance Crater | | |
| Coating | Additive | Aging | blend | Rater | Ra 2.5 | Size (Δ, μm) | | |
| Comp. | Example | Condition | solids) | (mA) | (μm) | L | F | M |
| C | Polymer | Non-aged | 0.5% | 166 | 0.240 | 4.60 | 5.35 | 4.69 |
| | E | | | | | | | |
| D | Polymer | Aged | 0.5% | 119 | 0.316 | 4.96 | 6.43 | 4.39 |
| | E | | | | | | | |
| E | Polymer | Non-aged | 0.5% | 252 | 0.160 | 4.94 | 6.25 | 6.13 |
| | F | | | | | | | |
| F | Polymer | Aged | 0.5% | 207 | 0.160 | 6.05 | 7.81 | 6.14 |
| | F | | | | | | | |
| G | Polymer | Non-aged | 1.0% | 126 | 0.542 | 5.94 | 6.26 | 6.89 |
| | E | | | | | | | |
| H | Polymer | Aged | 1.0% | Rupture occurred-Unable to collect data | | | | |
| | E | | | | | | | |
| I | Polymer | Non-aged | 1.0% | 106 | 0.171 | 6.04 | 7.38 | 6.14 |
| | F | | | | | | | |
| J | Polymer | Aged | 1.0% | 73 | 0.252 | 5.71 | 7.51 | 6.48 |
| | F | | | | | | | |

A significant improvement in oil spot resistance and edge coverage (enamel rater) are seen relative to the comparative examples in Table 10 above. In the case of coating composition H, rupture occurred throughout the panel and the coating could not be evaluated.

The data in Table 13 further demonstrates that addition Polymer F was more stable and therefore more resistant to degraded performance from aging when compared to comparative addition polymer E. For example, appearance values (Ra 2.5) for compositions that include comparative addition Polymer E appear indicate that the aged comparative addition polymer E in electrodepositable coating composition D resulted in a significant increase in Ra 2.5 when compared with electrodepositable coating composition C that included the non-aged comparative addition Polymer E where both electrodepositable coating compositions C and D included 0.5% by weight of the additive. In contrast, there was no difference in the Ra 2.5 between electrodepositable coating compositions E and F that included the non-aged and aged addition Polymer F. Likewise, electrodepositable coating composition H that included 1.0% by weight of aged comparative addition Polymer E resulted in a ruptured coating film whereas electrodepositable coating compositions I and J that included the non-aged and aged addition polymer F were able to coat out with only some increase in Ra 2.5 relative to the additive loading level.

### Example 11

### Preparation of Electrodepositable Coating Compositions K-N

Charges 1-5 were added to a plastic container stirred for 15 minutes from Table 14. Charges 6-9 was then added and stirred for an additional 10 minutes. The pigment paste and DI water were added and stirred for a minimum of 1 hour. The sub-total of charges 1-6 represents the total weight of resin blend. The bath composition had a solids content of 21.5% and a pigment to binder ratio of 0.12/1.0 by weight.

TABLE 14

| | | Amount | | | |
|---|---|---|---|---|---|
| | | Compo- | Compo- | Compo- | Compo- |
| | | sition K | sition L | sition M | sition N |
| Charge # | Material | (grams) | (grams) | (grams) | (grams) |
| 1 | Resin A | 690.55 | 690.55 | 690.55 | 690.55 |
| 2 | Resin B | 89.10 | 89.10 | 89.10 | 89.10 |
| 3 | Surfactant | 1.68 | 1.68 | 1.68 | 1.68 |
| | Blend A | | | | |
| 4 | Butyl carbitol | 12.42 | 12.42 | 12.42 | 12.42 |
| | formal¹ | | | | |
| 5 | DI Water | 245.25 | 245.25 | 245.25 | 245.25 |
| 6 | Polymer G | 26.96 | — | — | — |
| 7 | Polymer H | — | 26.74 | — | — |
| 8 | Polymer I | — | — | 26.47 | — |
| 9 | Polymer J | — | — | — | 25.85 |
| 10 | Pigment Paste² | 162.50 | 162.50 | 162.50 | 162.50 |
| 11 | DI Water | 780.00 | 780.00 | 780.00 | 780.00 |

¹MAZON 1651 available from BASF Corporation
²Pigment paste E6476 commercially sold by PPG.

After 20% ultrafiltration (and reconstitution with deionized water), coated panels were prepared using the same coating conditions and test panels as described above for Comparative Electrodepositable Coating Compositions A and B.

### Evaluation of Electrodepositable Coating Compositions K-N

Sample coated panels evaluated for appearance, edge coverage (enamel rating), and crater resistance using the same methods as describe above, with the results for electrodepositable coating compositions K-N reported in Table 15.

A significant improvement in oil spot resistance and edge coverage (enamel rater) are seen relative to the comparative examples A and B in Table 10 with best results in the case of electrodepositable coating composition K that includes addition polymer G.

TABLE 15

| | | Additive | | | | | |
|---|---|---|---|---|---|---|---|
| | | amount (% | | | | | |
| | | of resin | Enamel | | Oil Spot Resistance Crater Size | | |
| Coating | Additive | blend | Rater | | (Δ, μm) | | |
| Comp. | Example | solids) | (mA) | Ra μm | L | F | M |
| K | Polymer G | 1.0% | 118 | 0.249 | 3.86 | 3.90 | 7.63 |
| L | Polymer H | 1.0% | 207 | 0.297 | 4.26 | 6.14 | 6.56 |
| M | Polymer I | 1.0% | 181 | 0.183 | 5.11 | 9.59 | 6.35 |
| N | Polymer J | 1.0% | 248 | 0.212 | 9.48 | 8.09 | 8.08 |

### Example 13

### Preparation of Electrodepositable Coating Composition O

Charges 1-5 were added to a plastic container stirred for 15 minutes from Table 16. Charge 7-9 was then added and stirred for an additional 10 minutes. To evaluate the stability of Polymer E and F, the resins used in charge 6. The pigment paste and DI water were added and stirred for a minimum of 1 hour. The sub-total of charges 1-9 represents the total weight of resin blend. The bath composition had a solids content of 21.5% and a pigment to binder ratio of 0.12/1.0 by weight.

TABLE 16

| Charge # | Material | Composition O (grams) |
|---|---|---|
| 1 | Resin A | 690.55 |
| 2 | Resin B | 89.10 |
| 3 | Surfactant Blend A | 1.68 |
| 4 | Butyl carbitol formal¹ | 12.42 |
| 5 | DI Water | 245.25 |
| 6 | Polymer K | 21.19 |
| 7 | Pigment Paste¹ | 162.50 |
| 8 | DI Water | 780.00 |

¹MAZON 1651 available from BASF Corporation
² Pigment paste E6476 commercially sold by PPG

After 20% ultrafiltration (and reconstitution with deionized water), coated panels were prepared using the same coating conditions and test panels as described above for Comparative Electrodepositable Coating Compositions A and B.

Sample coated test panels were evaluated for appearance, edge coverage (enamel rating), and crater resistance using the same methods as describe above, with the results for electrodepositable coating composition O and reported in Table 16.

### Evaluation of Electrodepositable Coating Composition O

Appearance, enamel rater, and oil spot resistance values are reported in Table 17.

TABLE 17

| | | Concentration | Additive | | | | | |
|---|---|---|---|---|---|---|---|---|
| | | of Polymeric | amount (% | Enamel | | Oil Spot Resistance Crater | | |
| | Additive | Dispersant | of resin | Rater | Ra | Size (Δ, μm) | | |
| Comp. | Example | (wt %) | blend solids) | (mA) | μm | L | F | M |
| I | Polymer | 38% | 1.0% | 106 | 0.171 | 6.04 | 7.38 | 6.14 |
| | F | | | | | | | |
| O | Polymer | 55% | 1.0% | 200 | 0.196 | 7.31 | 6.58 | 6.71 |
| | K | | | | | | | |

The results in Table 17 demonstrate that varying the level of the polymeric dispersant of the addition polymer still allows for improved crater resistance, appearance and edge coverage compared to the control compositions.

### Example 12

### Preparation of Electrodepositable Coating Compositions P-R

Preparation of Crosslinker II: A blocked polyisocyanate crosslinker, suitable for use in electrodepositable coating resins, was prepared in the following manner Charges 2-5 listed in Table 18, below, were mixed in a flask set up for total reflux with stirring under nitrogen. The mixture was heated to a temperature of 35° C., and Charge 1 was added dropwise so that the temperature increased due to the reaction exotherm and was maintained under 100° C. After the addition of Charge 1 was complete, a temperature of 110° C. was established in the reaction mixture and the reaction mixture held at temperature until no residual isocyanate was detected by IR spectroscopy. Charges 6 and 7 were then added and the reaction mixture was allowed to stir for 30 minutes and cooled to ambient temperature.

TABLE 18
Components for the preparation of Crosslinker II

| | | Parts-by-weight |
|---|---|---|
| No. | Component | (grams) |
| 1 | Polymeric methylene diphenyl diisocyanate | 1340.00 |
| 2 | K Kat XK 620 (Zn amidine)¹ | 2.77 |
| 3 | Triethylene glycol monomethyl ether | 1149.40 |
| 4 | Polyethylene glycol 400² | 600.00 |
| 5 | Butyl Carbitol Formal | 12.00 |
| 6 | Propylene glycol methyl ether | 161.79 |
| 7 | Bisphenol A - ethylene oxide adduct | 132.00 |
| | (1/6 molar ratio BPA/EtO) | |

¹Available from King Industries
²Polyethylene glycol 400 available from Aldrich

Preparation of a Cationic, Amine-Functionalized, Polyepoxide-Based Resin (Resin System C): A cationic, amine-functionalized, polyepoxide-based polymeric resin, suitable for use in formulating electrodepositable coating compositions, was prepared in the following manner Charges 1-4 listed in Table 19, below, were combined in a flask set up for total reflux with stirring under nitrogen. The mixture was heated to a temperature of 130° C. and allowed to exotherm (175° C. maximum). A temperature of 145° C. was established in the reaction mixture and the reaction mixture was then held for 2 hours. Charges 5,6, and 9 were then introduced into the reaction mixture and a temperature of 100° C. was established in the reaction mixture. Charges 7-8 were then added to the reaction mixture quickly and the reaction mixture was allowed to exotherm. A temperature of 110° C. was established in the reaction mixture and the reaction mixture held for 1 hour. After the hold, component 10 was added and mixed for 15 minutes. Then the heating source was removed from the reaction mixture and the content of the flask was allowed to stir while cooling to room temperature.

TABLE 18
Components for the preparation of Resin System C

| | | |
|---|---|---|
| No. | Component | Parts-by-weight (grams) |

Resin Synthesis Stage

| | | |
|---|---|---|
| 1 | Bisphenol A diglycidyl ether | 614.7 |
| 2 | Bisphenol A | 265.42 |
| 3 | Bisphenol A - ethylene oxide adduct | 100 |
| | (1/6 molar ratio BPA/EtO) | |
| 4 | Ethyl triphenyl phosphonium bromide | 0.6 |
| 5 | Bisphenol A - ethylene oxide adduct | 139.7 |
| | (1/6 molar ratio BPA/EtO) | |
| 6 | Crosslinker II ¹ | 1234.3 |
| 7 | N-(3-Aminopropyl)diethanolamine | 21.7 |
| 8 | Methyl ethanol amine | 47.0 |
| 9 | Butyl Carbitol Formal | 112 |
| 10 | Propylene Glycol Methyl Ether | 292.1 |

¹ See synthesis of Crosslinker II, above

Preparation of Comparative Electrodepositable Coating Composition P: A stainless steel beaker (4-liters) was loaded with 799.4 grams of Resin System C (above) which had been warmed to 85° C. using thermocouple and heating mantle. A 1.5-inch Cowles blade was used to agitate the resin at 2500 RPM powered by a Fawcett air motor (Model 103A). Phosphoric acid (85% aq, 5.74 g) and then DI water (80.5 g) were added to Resin System C, which was then mixed for ten minutes. Next, ASP 200 (420 g available from BASF) was added over five minutes. This mixture was ground for one hour after which the degree of dispersion was determined by a Hegman gauge. To be adequately dispersed, a minimal reading of 5 had to be achieved. A separate mixture of water (1073.4 g) and sulfamic acid (9.82 g) were mixed in a 2-liter stainless steel beaker and heated to 60° C. The heated acid solution was then added to the resin pigment mixture over 5 minutes to yield a 47.5 wt. % solids dispersion. The dispersion was mixed for 1 hour while maintaining 60° C. After 1 hour, Deionized water (520 g) was added to the dispersion and it was allowed to cool to ambient temperatures under mild agitation. 2000 g of the dispersion was then taken and diluted with 1150 g of deionized water to make an electrocoat bath. After dilution, the addition of tin paste (E6278, commercially available from PPG Industries, 23.1 g) was then added to the bath.

Preparation of Electrodepositable Coating Composition Q including Polymer F: A stainless steel beaker (4-liters) was loaded with 799.4 grams of Resin System C (above) which had been warmed to 85° C. using thermocouple and heating mantle A 1.5-inch Cowles blade was used to agitate the resin at 2500 RPM powered by a Fawcett air motor (Model 103A). Phosphoric acid (85% aq, 5.74 g) and then DI water (80.5 g) were added to Resin System C, which was then mixed for ten minutes. Next, ASP 200 (420 g available from BASF) was added over five minutes. This mixture was ground for one hour after which the degree of dispersion was determined by a Hegman gauge. To be adequately dispersed, a minimal reading of 5 had to be achieved. A separate mixture of water (1073.4 g) and sulfamic acid (9.82 g) were mixed in a 2-liter stainless steel beaker and heated to 60° C. The heated acid solution was then added to the resin pigment mixture over 5 minutes to yield a 47.5 wt. % solids dispersion. The dispersion was mixed for 1 hour while maintaining 60° C. After 1 hour, Deionized water (520 g) was added to the dispersion and it was allowed to cool to ambient temperatures under mild agitation. 2000 g of the dispersion was then taken and diluted with 1150 g of deionized water to make an electrocoat bath. After dilution, the addition of tin paste (E6278, commercially available from PPG Industries, 23.1 g) was then added to the bath. Finally, Polymer F (19.2 g) was added to the electrocoat bath.

Preparation of Electrodepositable Coating Composition R including Polymer L: A stainless steel beaker (4-liters) was loaded with 799.4 grams of Resin System C (above) which had been warmed to 85° C. using thermocouple and heating mantle. A 1.5-inch Cowles blade was used to agitate the resin at 2500 RPM powered by a Fawcett air motor (Model 103A). Phosphoric acid (85% aq, 5.74 g) and then DI water (80.5 g) were added to Resin System C, which was then mixed for ten minutes. Next, ASP 200 (420 g available from BASF) was added over five minutes. This mixture was ground for one hour after which the degree of dispersion was determined by a Hegman gauge. To be adequately dispersed, a minimal reading of 5 had to be achieved. A separate mixture of water (1073.4 g) and sulfamic acid (9.82 g) were mixed in a 2-liter stainless steel beaker and heated to 60° C. The heated acid solution was then added to the resin pigment mixture over 5 minutes to yield a 47.5 wt. % solids dispersion. The dispersion was mixed for 1 hour while maintaining 60° C. After 1 hour, Deionized water (520 g) was added to the dispersion and it was allowed to cool to ambient temperatures under mild agitation. 2000 g of the dispersion was then taken and diluted with 1150 g of deionized water to make an electrocoat bath. After dilution, the addition of tin paste (E6278, commercially available from PPG Industries, 23.1 g) was then added to the bath. Finally, Polymer L (18.2 g) was added to the electrocoat bath.

### Evaluation of Burr Edge Coverage of Electrodepositable Coating Composition Examples P-R

As an additional means of testing edge corrosion, test panels were specially prepared from cold rolled steel panels, 4×12×0.031 inches, pretreated with CHEMFOS C700/DI and available from ACT Laboratories of Hillside, Michigan. The 4×12×0.31-inch panels were first cut into two 4×5¾-inch panels using a Di-Acro Hand Shear No. 24 (Di-Acro, Oak Park Heights, Minnesota). The panels are positioned in the cutter so that the burr edge from the cut along the 4-inch edge ends up on the opposite side from the top surface of the panel. Each 4×5¾ panel is then positioned in the cutter to remove a quarter of an inch from one of the 5¾-inch sides of the panel in such a manner that the burr resulting from the cut faces upward from the top surface of the panel. The above described electrodepositable paint compositions were then electrodeposited onto these specially prepared panels in a manner well known in the art by immersing them into a stirring bath at 32.2° C. and connecting the cathode of the direct current rectifier to the panel and connecting the anode of the direct current rectifier to the stainless-steel tubing used to circulate cooling water for bath temperature control. The voltage was increased from 0 to a set point voltage specific to the electrodepositable composition. This combination of time, temperature and voltage deposited a coating that when cured had a dry film thickness of 25 microns. Three panels were electrocoated for each paint composition. After electrodeposition, the panels were removed from the bath, rinsed vigorously with a spray of deionized water and cured by baking for 30 minutes at 177° C. in an electric oven. These cured panels were then placed into a salt spray cabinet such that the burr along the 5¾-inch side of the panel was horizontal and at the top with the burr edge facing outward towards the spray. Correspondingly, the burr along the 3¾-inch side of the panel was vertical, and the burr edge faced backward. These panels were subjected to salt spray exposure for a period of three days such that any areas along the 5¾-inch (150 mm) length of the burr, not well protected by the electrocoat will develop rust. The salt spray test is the same as that used for testing described in detail in ASTM B117. After the exposure to salt spray, the length of the burr still well protected by electrocoat, was measured (covered edge+rusted edge=150 mm). The burr length of each of three panels was evaluated. The % of coverage remaining along the burr length was then calculated. The average % of coverage of the three burr lengths from the three individual panels was then averaged. This test method is referred to herein as the Burr Edge Coverage Test Method.

The results for Electrodepositable Coating Compositions P-R are presented in Table 19 below.

TABLE 19
Evaluation of Electrodepositable
Coating Composition Examples P-R

| | | | | % Protected Edge |
|---|---|---|---|---|
| | | | | after Burr Edge |
| Electrodepositable | Addition | Coating | | Coverage Testing |
| Coating | Polymer | Thickness | Ra 2.5 | (average of |
| Composition | Additive | (μm) | (μm) | 3 panels) |
| Comparative | None | 25 | 0.48 | 10% |
| Composition P | | | | |
| Composition R | Polymer F | 25 | 1.27 | 90% |
| Composition Q | Polymer L | 25 | 0.43 | 90% |

The data in Table 19 demonstrates that the inclusion of Polymer F in Electrodepositable Coating Composition R and Polymer L in Electrodepositable Coating Composition Q results in a significant increase in edge protection versus Comparative Electrodepositable Coating Composition P. The data further demonstrates that Electrodepositable Coating Composition Q that includes Polymer L that includes a phosphorous acid-functional ethylenically unsaturated monomer achieves the improved edge coverage without a result to film appearance, as demonstrated by no increase in the Ra 2.5 value.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. An electrodepositable coating composition comprising:
(a) an addition polymer comprising a polymerization product of a polymeric dispersant and a second stage ethylenically unsaturated monomer composition comprising a second stage (meth)acrylamide monomer, wherein the second stage (meth)acrylamide monomer comprises at least 20% by weight of the second stage ethylenically unsaturated monomer composition, based on the total weight of the second stage ethylenically unsaturated monomer composition;
(b) an ionic salt group-containing film-forming polymer different from the addition polymer; and
(c) a curing agent.

2-3. (canceled)

4. The electrodepositable coating composition of claim 1, wherein the second stage (meth)acrylamide monomer comprises a second stage hydroxyl-functional (meth)acrylamide monomer.

5. The electrodepositable coating composition of claim 4, wherein the second stage ethylenically unsaturated monomer composition comprises the second stage hydroxyl-functional (meth)acrylamide monomer in an amount of at least 20% by weight, based on the total weight of the second stage ethylenically unsaturated monomer composition.

6. (canceled)

7. The electrodepositable coating composition of claim 4, wherein the second stage hydroxyl-functional (meth)acrylamide monomer comprises a C₁-C₆ hydroxyalkyl (meth)acrylamide.

8. The electrodepositable coating composition of claim 4, wherein the second stage hydroxyl-functional (meth)acrylamide monomer comprises hydroxymethyl (meth)acrylamide, hydroxyethyl (meth)acrylamide, hydroxypropyl (meth)acrylamide, 2-hydroxypropyl (meth)acrylamide, hydroxybutyl (meth)acrylamide, hydroxypentyl (meth)acrylamide, or any combination thereof.

9. The electrodepositable coating composition of claim 4, wherein the second stage hydroxyl-functional (meth)acrylamide monomer comprises a primary hydroxyl group.

10. The electrodepositable coating composition of claim 1, wherein the second stage ethylenically unsaturated monomer composition further comprises a phosphorous acid-functional ethylenically unsaturated monomer.

11. The electrodepositable coating composition of claim 10, wherein the second stage ethylenically unsaturated monomer composition comprises the phosphorous acid-functional ethylenically unsaturated monomer in an amount of 0.1% to 20% by weight, based on the total weight of the second stage ethylenically unsaturated monomer composition.

12. The electrodepositable coating composition of claim 1, wherein the polymeric dispersant comprises an ionic salt group-containing polymeric dispersant.

13. The electrodepositable coating composition of claim 1, wherein the polymeric dispersant comprises a polymerization product of a first stage ethylenically unsaturated monomer composition comprising (a) an epoxide functional ethylenically unsaturated monomer, and/or (b) an amino functional ethylenically unsaturated monomer.

14. The electrodepositable coating composition of claim 13, wherein the first stage ethylenically unsaturated monomer composition further comprising (c) an acid-functional ethylenically unsaturated monomer.

15. The electrodepositable coating composition of claim 14, wherein first stage ethylenically unsaturated monomer composition further comprises at least one of:
(d) a C₁-C₁₈ alkyl (meth)acrylate;
(e) a first stage hydroxyl-functional (meth)acrylate;
(f) a vinyl aromatic compound;
(g) a monomer comprising two or more ethylenically unsaturated groups per molecule;
(h) a first stage (meth)acrylamide monomer;
(i) a first stage monoalkyl (meth)acrylamide monomer;
(j) a first stage dialkyl (meth)acrylamide monomer; and/or
(k) a first stage hydroxyl-functional (meth)acrylamide monomer.

16. The electrodepositable coating composition of claim 1, wherein the addition polymer comprises 10% to 90% by weight of the residue of the polymeric dispersant, and 10% to 90% by weight of the residue of the second stage ethylenically unsaturated monomer composition, the % by weight being based on the total weight of the addition polymer.

17. (canceled)

18. The electrodepositable coating composition of claim 4, wherein the addition polymer has a theoretical hydroxyl-equivalent weight of 120 g/OH to 310 g/OH.

19. The electrodepositable coating composition of claim 4, wherein the addition polymer has a theoretical hydroxyl value of 190 mg of KOH/g of addition polymer to 400 mg of KOH/g of addition polymer.

20-21. (canceled)

22. The electrodepositable coating composition of claim 1, wherein the ionic salt group-containing film-forming polymer comprises a cationic salt group-containing film-forming polymer.

23. The electrodepositable coating composition of claim 1, wherein the ionic salt group-containing film-forming polymer comprises an anionic salt group-containing film-forming polymer.

24-26. (canceled)

27. The electrodepositable coating composition of claim 1, wherein
(a) the addition polymer is present in an amount of 0.01% to 5% by weight;
(b) the ionic salt group-containing film-forming polymer is present in an amount of 40% to 90% by weight; and
(c) the curing agent is present in an amount of 10% to 60% by weight, the % by weight based on the total weight of resin solids of the electrodepositable coating composition.

28. A method of coating a substrate comprising electrophoretically applying the electrodepositable coating composition of claim 1 to at least a portion of the substrate.

29. A coated substrate having a coating comprising:
(a) an addition polymer comprising a polymerization product of a polymeric dispersant and a second stage ethylenically unsaturated monomer composition comprising a second stage (meth)acrylamide monomer, wherein the second stage (meth)acrylamide monomer comprises at least 20% by weight of the second stage ethylenically unsaturated monomer composition, based on the total weight of the second stage ethylenically unsaturated monomer composition;
(b) an ionic salt group-containing film-forming polymer different from the addition polymer; and
(c) a curing agent.

30-36. (canceled)
